(19) United States
(12) Patent Application Publication
(10) Pub. No.: US 2024/0023547 A1
(43) Pub. Date: Jan. 25, 2024

(54) AGROCHEMICAL COMPOSITIONS AND METHODS OF MAKING AND USING THE SAME

(71) Applicant: Provivi, Inc., Santa Monica, CA (US)

(72) Inventors: Ivan DEMIANETS, Los Angeles, CA (US); Chanjoong KIM, Los Angeles, CA (US)

(21) Appl. No.: 18/360,553

(22) Filed: Jul. 27, 2023

Related U.S. Application Data
(63) Continuation of application No. PCT/US2022/014592, filed on Jan. 31, 2022.
(60) Provisional application No. 63/143,575, filed on Jan. 29, 2021.

(51) Int. Cl. A01N 37/06; A01N 25/10; A01N 25/12; A01P 19/00; C05G 5/40; C05F 11/00

(52) U.S. Cl. CPC A01N 37/06; A01N 25/10; A01N 25/12; A01P 19/00; C05G 5/40; C05F 11/00

(57) ABSTRACT

This disclosure provides agrochemical compositions and methods of manufacturing and using the same. In embodiments, the present disclosure relates to agrochemical compositions comprising one or more pheromones.

### CROSS-REFERENCE TO RELATED APPLICATION

This application is a continuation of International Patent Application No. PCT/US2022/014592, filed Jan. 31, 2022, which claims priority to U.S. Provisional Patent Application No. 63/143,575, filed Jan. 29, 2021, each of which is hereby incorporated by reference in its entirety.

### TECHNICAL FIELD

The disclosure provides for agricultural compositions comprising active ingredients such as pheromones. In embodiments, the disclosure teaches polymer compositions that release active ingredients in a controlled manner. The compositions may be formulated in a myriad of delivery forms that include, inter alia, granules, flakes, strings, and dispensers.

### BACKGROUND

The world's population is dramatically increasing and concomitant with that rise in population is an urgent need to meet the burgeoning population's food demands. Traditionally, modern agriculture has relied upon chemistry to help control pest populations and ensure steady and predictable food yields. However, there is an increasing recognition that agricultural chemicals may have a detrimental effect upon the environment. Thus, there is an urgent demand for a more sustainable way to meet the world's food requirements and ultimately transition chemistry-based row crop agriculture to a more sustainable and environmentally friendly paradigm.

### SUMMARY OF THE INVENTION

The present disclosure provides agricultural compositions that release active ingredients such as pheromones, which are able to replace detrimental agriculture chemistries.

In aspects, the present disclosure relates to a controlled-release agrochemical dispenser comprising: a matrix; and a semiochemical composition contained within the matrix.

In aspects, the present disclosure relates to a controlled-release agrochemical flake comprising a matrix; and a semiochemical composition contained within the matrix.

In aspects, the present disclosure relates to a controlled-release agrochemical granule comprising: a matrix; and a semiochemical composition contained within the matrix.

In embodiments, the matrix comprises a binder.

In embodiments, the binder is a biodegradable polymer. In embodiments, the biodegradable polymer is selected from the group consisting of polycaprolactone (PCL), poly(butylene adipate-co-terephthalate) (PBAT), polybutylene succinate (PBS), polyhydroxyalkanoate (PHA) and polylactic acid (PLA). In embodiments, the dispenser, granule, and/or flake comprises about 10 wt % to about 98 wt % of the biodegradable polymer.

In embodiments, the binder is a non-biodegradable polymer. In embodiments, the non-biodegradable polymer is selected from the group consisting of low density polyethylene (LDPE), ethylene-vinyl acetate (EVA), high density polyethylene (HDPE), and polyvinyl acetate (PVA).

In embodiments, wherein the semiochemical composition is miscible in the binder. In embodiments, the semiochemical composition is immiscible in the binder. In embodiments, the semiochemical composition comprises droplets in the matrix dispenser.

In embodiments, the dispenser, flake, and/or granule further comprises a filler contained within the matrix. In embodiments, the filler is selected from the group consisting of a clay (including organoclay), a zeolite, talcum, shredded hay, cotton, cork, hemp, wood chips, wood dust, wood excelsior, microcrystalline cellulose, paper pulp, kaolin, calcined kaolin, chitosan, and mixtures thereof. In embodiments, the filler is a biomass from a fermentation. In embodiments, the filler is an active filler (i.e., a filler that retains the semiochemical). In embodiments, the dispenser, granule, and/or flake comprises about 1 wt % to about 80 wt % of filler.

In embodiments, the dispenser, granule, and/or flake comprises polycaprolactone and microcrystalline cellulose. In embodiments, the dispenser, granule, and/or flake comprises polycaprolactone and calcined kaolin. In embodiments, the dispenser, granule, and/or flake comprises PLA and microcrystalline cellulose. In embodiments, the dispenser, granule, and/or flake comprises EVA and microcrystalline cellulose. In embodiments, the dispenser, granule, and/or flake comprises EVA and calcined kaolin. In embodiments, the dispenser, granule, and/or flake comprises PBS and microcrystalline cellulose. In embodiments, the dispenser, granule, and/or flake comprises PHA and microcrystalline cellulose. In embodiments, the dispenser, granule, and/or flake comprises PBS and calcined kaolin.

In embodiments, the weight ratio of semiochemical composition to binder is 99:1 to 60:40. In embodiments, the weight ratio of semiochemical composition to binder is 20:80 to 80:20. In embodiments, the weight ratio of semiochemical composition to binder is about 1:1. In embodiments, the weight ratio of filler to semiochemical composition is 99:1 to 60:40. In embodiments, the weight ratio of filler to semiochemical composition is about 1:1.

In embodiments, the dispenser, granule, and/or flake further comprises an antioxidant. In embodiments, the dispenser, granule, and/or flake further comprises about 0.01 wt % to about 5 wt % of an antioxidant.

In embodiments, the dispenser, granule, and/or flake further comprises a UV-blocking agent. In embodiments, the UV-blocking agent is selected from the group consisting of methyl cinnamate, iron oxides, carbon black, and octabenzone.

In embodiments, the dispenser, granule, and/or flake further comprises an anticaking agent. In embodiments, the anticaking agent is selected from the group consisting of charcoal, amorphous silica, and fumed silica. In embodiments, the dispenser, granule, and/or flake comprises about 0 wt % to about 2 wt % of an anticaking agent.

In embodiments, the dispenser, granule, and/or flake further comprises an additive contained within the matrix, wherein the additive is selected from the group consisting of a dye, reflectant, inorganic salt and organic salt.

In embodiments, the dispenser is in the shape of a cylindrical disc or rectangular prism. In embodiments, the surface area of the dispenser is from about 50 cm² to about 150 cm². In embodiments, the thickness of the dispenser is from about 0.1 mm to about 10 mm. In embodiments, the thickness of the dispenser is from about 1 mm to about 3 mm. In embodiments, the thickness of the dispenser is from about 1 mm to about 2 mm.

In embodiments, the shape of the granule is a cylinder, cube, sphere, irregular 3d object, or a mixture thereof. In embodiments, the mean dimension of the granule is from about 0.1 mm to about 10 mm. In embodiments, the mean volume of the granule is from about 0.001 mm³ to about 1000 mm³.

In embodiments, the semiochemical composition is selected from the group consisting of an allomone, a kairomone, a pheromone, and mixtures thereof.

In embodiments, the semiochemical composition comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof.

In embodiments, the semiochemical composition comprises (Z)-9-Hexadecenal (Z9-16Ald), (Z)-11-Hexadecenal (Z11-16Ald), (Z)-13-Octadecenal (Z13-18Ald), and (Z)-9-Octadecenal (Z9-18Aid).

In embodiments, the semiochemical composition comprises about 75 wt % of (Z)-9-Hexadecenal (Z9-16Ald), about 10 wt % (Z)-11-Hexadecenal (Z11-16Ald), about 8 wt % of (Z)-13-Octadecenal (Z13-18Ald), and about 7 wt % of (Z)-9-Octadecenal (Z9-18Ald).

In embodiments, the semiochemical composition comprises (Z)-9-Tetradecenyl Acetate (Z9-14Ac) and (Z)-11-Hexadecenyl Acetate (Z11-16Ac).

In embodiments, the semiochemical composition comprises about 87 wt % of (Z)-9-Tetradecenyl Acetate (Z9-14Ac) and about 13 wt % of (Z)-11-Hexadecenyl Acetate (Z11-16Ac).

In embodiments, the dispenser, granule, and/or flake comprises about 1% to about 50% by weight of the semiochemical composition. In embodiments, the dispenser, granule, and/or flake comprises about 1 mg to about 5 g of the semiochemical composition.

In embodiments, the dispenser, granule, and/or flake releases about 25 mg of the semiochemical per day after installation in a field. In embodiments, the dispenser, granule, and/or flake releases the semiochemical for at least about month after installation in a field. In embodiments, the dispenser, granule, and/or flake provides zero order release of the semiochemical for at least about month after installation in a field.

In embodiments, the present disclosure provides a controlled-release agrochemical dispenser comprising flakes or granules. In embodiments, the flakes or granules are joined together by glue.

In aspects, the present disclosure provides methods of controlling fall armyworm (FAW) in corn, the methods comprising applying an effective amount of the controlled-release dispenser, granule, or flake to a corn field.

In embodiments, the application rate is from about 50 g a.i./ha to about 150 g a.i./ha. In embodiments, the method controls FAW for about 60 days following application.

In aspects, the present disclosure provides methods of controlling yellow rice stemborer in rice, the methods comprising applying an effective amount of the controlled-release dispenser, granule, or flake to a rice paddy field.

In aspects, the present disclosure provides a process for making a controlled-release agrochemical dispenser, flake or granule, the method comprising: (a) homogenizing a filler, binder and a semiochemical composition and (b) extruding the homogenized mixture.

In embodiments, the step (b) is conducted by twin-screw extrusion.

### BRIEF DESCRIPTION OF THE DRAWINGS

FIGS. 1A-1C show representative images of formulations of Example 1 (FIG. 1A) and the same formulations in an environmental chamber at 50° C., 50% RH at 0 h (FIG. 1B) and at 50° C., 50% RH at 1 h (FIG. 1C) in accordance with embodiments of the present disclosure.

FIG. 2 shows representative images of formulations of Example 1 comprising kaolin (Sigma brand) (samples A and G), calcined kaolin (KaMin brand, 70C) (samples B and H), kaolin (KaMin brand, 80B) (sample C), microcrystalline cellulose (MCC 101) (sample D), zeolite (Heiltrophen brand, EU) (sample E), zeolite (KMI brand) (sample F), and talcum (FisherSci brand) (sample I) in accordance with embodiments of the present disclosure.

FIG. 3 shows a representative graph depicting the performance of the formulations of FIG. 2 in an environmental chamber at 40° C., 50% RH for at least 90 days in accordance with embodiments of the present disclosure.

FIGS. 4A-4D show exemplary images of formulations of Example 1 formulated into dispensers (FIGS. 4A-4B), flakes (FIG. 4C), and granules (FIG. 4D) in accordance with embodiments of the present disclosure.

FIG. 5 shows a representative graph depicting the performance of granules and flakes formed from Formulation H (70C) and Formulation D (MCC) of Example 1 in an environmental chamber at 40° C., 50% RH for 36 days in accordance with embodiments of the present disclosure.

FIGS. 6A-6C show representative images of Formulations A-D of Example 2 before (FIG. 6A) and after grinding in a mortar (FIG. 6B) for 30 seconds and dispensers formed from Formulation D (FIG. 6C) in accordance with embodiments of the present disclosure.

FIGS. 7A-7C show representative images of granules of Example 4 to include MCC-based granules produced at 55 lb. run (FIG. 7A), 70C-based granules produced at 55 lb. run (FIG. 7B), and MCC-based granules produced at 55 lb. and 70C-based granules produced at 3 lb. (2×2 mm size) and produced at 55 lb. run (4×2×2 mm size) (FIG. 7C) in accordance with embodiments of the present disclosure.

FIGS. 8A-8C show representative images of flakes of Example 4 produced through a flake production process from a heat pressed sheet (FIGS. 8A-8B) to the resulting flakes (FIG. 8C) in accordance with embodiments of the present disclosure.

FIG. 9 is a representative graph showing gravimetric weight loss of 40° C., 50% RH in an environmental chamber of the granules and flakes of FIGS. 7A-7C and FIGS. 8A-8C, respectively in accordance with embodiments of the present disclosure.

FIGS. 10A-10D show representative graphs depicting the performance of the granules and flakes of FIGS. 7A-7C and FIGS. 8A-8C, respectively in an environmental chamber at 40° C., 50% RH for 30 days in accordance with embodiments of the present disclosure.

FIG. 11 shows a representative graph depicting the gravimetric weight loss at 40° C., 50% RH in an environment chamber of the granules and flakes of FIGS. 7A-7C and FIGS. 8A-8C, respectively in accordance with embodiments of the present disclosure.

FIG. 12 shows a representative graph depicting a soil assay of the granules of FIGS. 7A-7C in Florida in accordance with embodiments of the present disclosure.

FIGS. 13A-13E show representative graphs of moth capture data of Example 5 including average moth capture by formulation and dose 88 days after installation (FIG. 13A), average moth capture by formulation and dose up to 60 DAI (FIG. 13B) and 60 DAI to 88 DAI (FIG. 13C), and percentage of male moth suppression reached by formulation and dose 88 days after installation (FIGS. 13D-13E) in Rondonopolis-MT in accordance with embodiments of the present disclosure.

FIGS. 14A-14E show representative graphs of moth capture data of Example 5 including average cumulative moth capture by formulation and dose 83 days after installation (FIG. 14A), average moth capture by formulation and dose up to 60 DAI (FIG. 14B) and 60 DAI to 83 DAI (FIG. 14C), and percentage of male moth suppression reached by formulation and dose 83 days after installation (FIGS. 14D-14E) in Itiquira-MT in accordance with embodiments of the present disclosure.

### DETAILED DESCRIPTION OF THE INVENTION

### Definitions

The term “about” when immediately preceding a numerical value means ±up to 10% of the numerical value. For example, “about” a numerical value means ±up to 10% of the numerical value, in embodiments, ±up to 10%, ±up to 9%, ±up to 8%, ±up to 7%, ±up to 6%, ±up to 5%, ±up to 4%, ±up to 3%, ±up to 2%, ±up to 1%, ±up to less than 1%, or any other value or range of values therein.

Throughout the present disclosure, numerical ranges are provided for certain quantities. These ranges comprise all subranges therein. Thus, the range “from 50 to 80” includes all possible ranges therein (e.g., 51-79, 52-78, 53-77, 54-76, 55-75, 60-70, etc.). Furthermore, all values within a given range may be an endpoint for the range encompassed thereby (e.g., the range 50-80 includes the ranges with endpoints such as 55-80, 50-75, etc.).

The term “effective amount” refers to an amount of an agrochemical composition that, when applied to an area (for example, a field), is capable of achieving an intended result (such as controlling a population of one or more pests in a field). The actual amount which comprises the “effective amount” will vary depending on a number of conditions including, but not limited to, the type and level of infestation; the type of agrochemical composition used; the concentration of the active ingredient(s); how the composition is provided, for example, the type of composition used (e.g., granules, flakes, and dispensers); the type of area to be treated; the length of time the method is to be used for; and environmental factors such as temperature, wind speed and direction, rainfall and humidity in the area where the agrochemical composition is applied. A skilled practitioner can readily determine the appropriate amount using methods known in the agricultural arts.

All weight percentages (i.e., “% by weight” and “wt. %” and w/w) referenced herein, unless otherwise indicated, are relative to the total weight of the mixture or composition, as the case may be.

### Active Ingredients

The agrochemical compositions of the present disclosure comprise an active ingredient. Persons skilled in the art can select the type and amount an active ingredient, or mixture of active ingredients (such as a pheromone), that, when used in an agrochemical composition of the present disclosure (infra), is effective for a particular agricultural application (such as the control of Spodoptera frugiperda (fall armyworm)). The following active ingredients are non-limiting examples of active ingredients that may be used, alone or in combination, in the agrochemical compositions of the present disclosure.

In embodiments, the active ingredient comprises a semiochemical. In embodiments, the semiochemical comprises allomone, a kairomone, a pheromone, and mixtures thereof.

In embodiments, the semiochemical comprises a pheromone. Most pheromones comprise a hydrocarbon skeleton with the terminal hydrogen substituted by a functional group (Ryan MF (2002). Insect Chemoreception. Fundamental and Applied. Kluwer Academic Publishers). The presence of one or more double bonds, generated by the loss of hydrogens from adjacent carbons, determines the degree of unsaturation of the molecule and alters the designation of a hydrocarbon from -ane (no multiple bonds) to -ene. The presence of two and three double bonds is indicated by ending the name with -diene and -triene, respectively. The position of each double bond is represented by a numeral corresponding to that of the carbon from which it begins, with each carbon numbered from that attached to the functional group. The carbon to which the functional group is attached is designated -1-. Pheromones may have, but are not limited to, hydrocarbon chain lengths numbering 10 (deca-), 12 (dodeca-), 14 (tetradeca-), 16 (hexadeca-), or 18 (octadeca-) carbons long. The presence of a double bond has another effect. It precludes rotation of the molecule by fixing it in one of two possible configurations, each representing geometric isomers that are different molecules. These are designated either E (from the German word Entgegen, opposite) or Z (Zusammen, together), when the carbon chains are connected on the opposite (trans) or same (cis) side, respectively, of the double bond.

In embodiments, the pheromone comprises one or more of a sex, trail, territory, or aggregation pheromone.

In embodiments, sex pheromones include the C6-C20 pheromones described in Table 1. In embodiments, the compositions of the present disclosure comprise a sex pheromone described in Table 1. In embodiments, the compositions of the present disclosure comprise a mixture of sex pheromone in Table 1.

TABLE 1
Sex Pheromones of the Present Disclosure

| Name | Name |
|---|---|
| (E)-2-Decen-1-ol | (Z,E)-9,11-Tetradecadien-1-ol |
| (E)-2-Decenyl acetate | (Z,E)-9,11-Tetradecadienyl acetate |
| (E)-2-Decenal | (Z,E)-9,11-Tetradecadienal |
| (Z)-2-Decen-1-ol | (Z,Z)-9,11-Tetradecadien-1-ol |
| (Z)-2-Decenyl acetate | (Z,Z)-9,11-Tetradecadienyl acetate |
| (Z)-2-Decenal | (Z,Z)-9,11-Tetradecadienal |
| (E)-3-Decen-1-ol | (E,E)-9,12-Tetradecadienyl acetate |
| (Z)-3-Decenyl acetate | (Z,E)-9,12-Tetradecadien-1-ol |
| (Z)-3-Decen-1-ol | (Z,E)-9,12-Tetradecadienyl acetate |
| (Z)-4-Decen-1-ol | (Z,E)-9,12-Tetradecadienal |
| (E)-4-Decenyl acetate | (Z,Z)-9,12-Tetradecadien-1-ol |
| (Z)-4-Decenyl acetate | (Z,Z)-9,12-Tetradecadienyl acetate |
| (Z)-4-Decenal | (E,E)-10,12-Tetradecadien-1-ol |
| (E)-5-Decen-1-ol | (E,E)-10,12-Tetradecadienyl acetate |
| (E)-5-Decenyl acetate | (E,E)-10,12-Tetradecadienal |
| (Z)-5-Decen-1-ol | (E,Z)-10,12-Tetradecadienyl acetate |
| (Z)-5-Decenyl acetate | (Z,E)-10,12-Tetradecadienyl acetate |
| (Z)-5-Decenal | (Z,Z)-10,12-Tetradecadien-1-ol |
| (E)-7-Decenyl acetate | (Z,Z)-10,12-Tetradecadienyl acetate |
| (Z)-7-Decenyl acetate | (E,Z,Z)-3,8,11-Tetradecatrienyl acetate |
| (E)-8-Decen-1-ol | (E)-8-Pentadecen-1-ol |
| (E,E)-2,4-Decadienal | (E)-8-Pentadecenyl acetate |
| (E,Z)-2,4-Decadienal | (Z)-8-Pentadecen-1-ol |
| (Z,Z)-2,4-Decadienal | (Z)-8-Pentadecenyl acetate |
| (E,E)-3,5-Decadienyl acetate | (Z)-9-Pentadecenyl acetate |
| (Z,E)-3,5-Decadienyl acetate | (E)-9-Pentadecenyl acetate |
| (Z,Z)-4,7-Decadien-1-ol | (Z)-10-Pentadecenyl acetate |
| (Z,Z)-4,7-Decadienyl acetate | (Z)-10-Pentadecenal |
| (E)-2-Undecenyl acetate | (E)-12-Pentadecenyl acetate |
| (E)-2-Undecenal | (Z)-12-Pentadecenyl acetate |
| (Z)-5-Undecenyl acetate | (Z,Z)-6,9-Pentadecadien-1-ol |
| (Z)-7-Undecenyl acetate | (Z,Z)-6,9-Pentadecadienyl acetate |
| (Z)-8-Undecenyl acetate | (Z,Z)-6,9-Pentadecadienal |
| (Z)-9-Undecenyl acetate | (E,E)-8,10-Pentadecadienyl acetate |
| (E)-2-Dodecenal | (E,Z)-8,10-Pentadecadien-1-ol |
| (Z)-3-Dodecen-1-ol | (E,Z)-8,10-Pentadecadienyl acetate |
| (E)-3-Dodecenyl acetate | (Z,E)-8,10-Pentadecadienyl acetate |
| (Z)-3-Dodecenyl acetate | (Z,Z)-8,10-Pentadecadienyl acetate |
| (E)-4-Dodecenyl acetate | (E,Z)-9,11-Pentadecadienal |
| (E)-5-Dodecen-1-ol | (Z,Z)-9,11-Pentadecadienal |
| (E)-5-Dodecenyl acetate | (Z)-3-Hexadecenyl acetate |
| (Z)-5-Dodecen-1-ol | (E)-5-Hexadecen-1-ol |
| (Z)-5-Dodecenyl acetate | (E)-5-Hexadecenyl acetate |
| (Z)-5-Dodecenal | (Z)-5-Hexadecen-1-ol |
| (E)-6-Dodecen-1-ol | (Z)-5-Hexadecenyl acetate |
| (Z)-6-Dodecenyl acetate | (E)-6-Hexadecenyl acetate |
| (E)-6-Dodecenal | (E)-7-Hexadecen-1-ol |
| (E)-7-Dodecen-1-ol | (E)-7-Hexadecenyl acetate |
| (E)-7-Dodecenyl acetate | (E)-7-Hexadecenal |
| (E)-7-Dodecenal | (Z)-7-Hexadecen-1-ol |
| (Z)-7-Dodecen-1-ol | (Z)-7-Hexadecenyl acetate |
| (Z)-7-Dodecenyl acetate | (Z)-7-Hexadecenal |
| (Z)-7-Dodecenal | (E)-8-Hexadecenyl acetate |
| (E)-8-Dodecen-1-ol | (E)-9-Hexadecen-1-ol |
| (E)-8-Dodecenyl acetate | (E)-9-Hexadecenyl acetate |
| (E)-8-Dodecenal | (E)-9-Hexadecenal |
| (Z)-8-Dodecen-1-ol | (Z)-9-Hexadecen-1-ol |
| (Z)-8-Dodecenyl acetate | (Z)-9-Hexadecenyl acetate |
| (E)-9-Dodecen-1-ol | (Z)-9-Hexadecenal |
| (E)-9-Dodecenyl acetate | (E)-10-Hexadecen-1-ol |
| (E)-9-Dodecenal | (E)-10-Hexadecenal |
| (Z)-9-Dodecen-1-ol | (Z)-10-Hexadecenyl acetate |
| (Z)-9-Dodecenyl acetate | (Z)-10-Hexadecenal |
| (Z)-9-Dodecenal | (E)-11-Hexadecen-1-ol |
| (E)-10-Dodecen-1-ol | (E)-11-Hexadecenyl acetate |
| (E)-10-Dodecenyl acetate | (E)-11-Hexadecenal |
| (E)-10-Dodecenal | (Z)-11-Hexadecen-1-ol |
| (Z)-10-Dodecen-1-ol | (Z)-11-Hexadecenyl acetate |
| (Z)-10-Dodecenyl acetate | (Z)-11-Hexadecenal |
| (E,Z)-3,5-Dodecadienyl acetate | (Z)-12-Hexadecenyl acetate |
| (Z,E)-3,5-Dodecadienyl acetate | (Z)-12-Hexadecenal |
| (Z,Z)-3,6-Dodecadien-1-ol | (E)-14-Hexadecenal |
| (E,E)-4,10-Dodecadienyl acetate | (Z)-14-Hexadecenyl acetate |
| (E,E)-5,7-Dodecadien-1-ol | (E,E)-1,3-Hexadecadien-1-ol |
| (E,E)-5,7-Dodecadienyl acetate | (E,Z)-4,6-Hexadecadien-1-ol |
| (E,Z)-5,7-Dodecadien-1-ol | (E,Z)-4,6-Hexadecadienyl acetate |
| (E,Z)-5,7-Dodecadienyl acetate | (E,Z)-4,6-Hexadecadienal |
| (E,Z)-5,7-Dodecadienal | (E,Z)-6,11-Hexadecadienyl acetate |
| (Z,E)-5,7-Dodecadien-1-ol | (E,Z)-6,11-Hexadecadienal |
| (Z,E)-5,7-Dodecadienyl acetate | (Z,Z)-7,10-Hexadecadien-1-ol |
| (Z,E)-5,7-Dodecadienal | (Z,Z)-7,10-Hexadecadienyl acetate |
| (Z,Z)-5,7-Dodecadienyl acetate | (Z,E)-7,11-Hexadecadien-1-ol |
| (Z,Z)-5,7-Dodecadienal | (Z,E)-7,11-Hexadecadienyl acetate |
| (E,E)-7,9-Dodecadienyl acetate | (Z,E)-7,11-Hexadecadienal |
| (E,Z)-7,9-Dodecadien-1-ol | (Z,Z)-7,11-Hexadecadien-1-ol |
| (E,Z)-7,9-Dodecadienyl acetate | (Z,Z)-7,11-Hexadecadienyl acetate |
| (E,Z)-7,9-Dodecadienal | (Z,Z)-7,11-Hexadecadienal |
| (Z,E)-7,9-Dodecadien-1-ol | (Z,Z)-8,10-Hexadecadienyl acetate |
| (Z,E)-7,9-Dodecadienyl acetate | (E,Z)-8,11-Hexadecadienal |
| (Z,Z)-7,9-Dodecadien-1-ol | (E,E)-9,11-Hexadecadienal |
| (Z,Z)-7,9-Dodecadienyl acetate | (E,Z)-9,11-Hexadecadienyl acetate |
| (E,E)-8,10-Dodecadien-1-ol | (E,Z)-9,11-Hexadecadienal |
| (E,E)-8,10-Dodecadienyl acetate | (Z,E)-9,11-Hexadecadienal |
| (E,E)-8,10-Dodecadienal | (Z,Z)-9,11-Hexadecadienal |
| (E,Z)-8,10-Dodecadien-1-ol | (E,E)-10,12-Hexadecadien-1-ol |
| (E,Z)-8,10-Dodecadienyl acetate | (E,E)-10,12-Hexadecadienyl acetate |
| (E,Z)-8,10-Dodecadienal | (E,E)-10,12-Hexadecadienal |
| (Z,E)-8,10-Dodecadien-1-ol | (E,Z)-10,12-Hexadecadien-1-ol |
| (Z,E)-8,10-Dodecadienyl acetate | (E,Z)-10,12-Hexadecadienyl acetate |
| (Z,E)-8,10-Dodecadienal | (E,Z)-10,12-Hexadecadienal |
| (Z,Z)-8,10-Dodecadien-1-ol | (Z,E)-10,12-Hexadecadienyl acetate |
| (Z,Z)-8,10-Dodecadienyl acetate | (Z,E)-10,12-Hexadecadienal |
| (Z,E,E)-3,6,8-Dodecatrien-1-ol | (Z,Z)-10,12-Hexadecadienal |
| (Z,Z,E)-3,6,8-Dodecatrien-1-ol | (E,E)-11,13-Hexadecadien-1-ol |
| (E)-2-Tridecenyl acetate | (E,E)-11,13-Hexadecadienyl acetate |
| (Z)-2-Tridecenyl acetate | (E,E)-11,13-Hexadecadienal |
| (E)-3-Tridecenyl acetate | (E,Z)-11,13-Hexadecadien-1-ol |
| (E)-4-Tridecenyl acetate | (E,Z)-11,13-Hexadecadienyl acetate |
| (Z)-4-Tridecenyl acetate | (E,Z)-11,13-Hexadecadienal |
| (Z)-4-Tridecenal | (Z,E)-11,13-Hexadecadien-1-ol |
| (E)-6-Tridecenyl acetate | (Z,E)-11,13-Hexadecadienyl acetate |
| (Z)-7-Tridecenyl acetate | (Z,E)-11,13-Hexadecadienal |
| (E)-8-Tridecenyl acetate | (Z,Z)-11,13-Hexadecadien-1-ol |
| (Z)-8-Tridecenyl acetate | (Z,Z)-11,13-Hexadecadienyl acetate |
| (E)-9-Tridecenyl acetate | (Z,Z)-11,13-Hexadecadienal |
| (Z)-9-Tridecenyl acetate | (E,E)-10,14-Hexadecadienal |
| (Z)-10-Tridecenyl acetate | (Z,E)-11,14-Hexadecadienyl acetate |
| (E)-11-Tridecenyl acetate | (E,E,Z)-4,6,10-Hexadecatrien-1-ol |
| (Z)-11-Tridecenyl acetate | (E,E,Z)-4,6,10-Hexadecatrienyl acetate |
| (E,Z)-4,7-Tridecadienyl acetate | (E,Z,Z)-4,6,10-Hexadecatrien-1-ol |
| (Z,Z)-4,7-Tridecadien-1-ol | (E,Z,Z)-4,6,10-Hexadecatrienyl acetate |
| (Z,Z)-4,7-Tridecadienyl acetate | (E,E,Z)-4,6,11-Hexadecatrienyl acetate |
| (E,Z)-5,9-Tridecadienyl acetate | (E,E,Z)-4,6,11-Hexadecatrienal |
| (Z,E)-5,9-Tridecadienyl acetate | (Z,Z,E)-7,11,13-Hexadecatrienal |
| (Z,Z)-5,9-Tridecadienyl | (E,E,E)-10,12,14-Hexadecatrienyl |
| acetate | acetate |
| (Z,Z)-7,11-Tridecadienyl acetate | (E,E,E)-10,12,14-Hexadecatrienal |
| (E,Z,Z)-4,7,10-Tridecatrienyl | (E,E,Z)-10,12,14-Hexadecatrienyl |
| acetate | acetate |
| (E)-3-Tetradecen-1-ol | (E,E,Z)-10,12,14-Hexadecatrienal |
| (E)-3-Tetradecenyl acetate | (E,E,Z,Z)-4,6,11,13-Hexadecatetraenal |
| (Z)-3-Tetradecen-1-ol | (E)-2-Heptadecenal |
| (Z)-3-Tetradecenyl acetate | (Z)-2-Heptadecenal |
| (E)-5-Tetradecen-1-ol | (E)-8-Heptadecen-1-ol |
| (E)-5-Tetradecenyl acetate | (E)-8-Heptadecenyl acetate |
| (E)-5-Tetradecenal | (Z)-8-Heptadecen-1-ol |
| (Z)-5-Tetradecen-1-ol | (Z)-9-Heptadecenal |
| (Z)-5-Tetradecenyl acetate | (E)-10-Heptadecenyl acetate |
| (Z)-5-Tetradecenal | (Z)-11-Heptadecen-1-ol |
| (E)-6-Tetradecenyl acetate | (Z)-11-Heptadecenyl acetate |
| (Z)-6-Tetradecenyl acetate | (E,E)-4,8-Heptadecadienyl acetate |
| (E)-7-Tetradecen-1-ol | (Z,Z)-8,10-Heptadecadien-1-ol |
| (E)-7-Tetradecenyl acetate | (Z,Z)-8,11-Heptadecadienyl acetate |
| (Z)-7-Tetradecen-1-ol | (E)-2-Octadecenyl acetate |
| (Z)-7-Tetradecenyl acetate | (E)-2-Octadecenal |
| (Z)-7-Tetradecenal | (Z)-2-Octadecenyl acetate |
| (E)-8-Tetradecenyl acetate | (Z)-2-Octadecenal |
| (Z)-8-Tetradecen-1-ol | (E)-9-Octadecen-1-ol |
| (Z)-8-Tetradecenyl acetate | (E)-9-Octadecenyl acetate |
| (Z)-8-Tetradecenal | (E)-9-Octadecenal |
| (E)-9-Tetradecen-1-ol | (Z)-9-Octadecen-1-ol |
| (E)-9-Tetradecenyl acetate | (Z)-9-Octadecenyl acetate |
| (Z)-9-Tetradecen-1-ol | (Z)-9-Octadecenal (Z9-18Ald) |
| (Z)-9-Tetradecenyl acetate | (E)-11-Octadecen-1-ol |
| (Z)-9-Tetradecenal | (E)-11-Octadecenal |
| (E)-10-Tetradecenyl acetate | (Z)-11-Octadecen-1-ol |
| (Z)-10-Tetradecenyl acetate | (Z)-11-Octadecenyl acetate |
| (E)-11-Tetradecen-1-ol | (Z)-11-Octadecenal |
| (E)-11-Tetradecenyl acetate | (E)-13-Octadecenyl acetate |
| (E)-11-Tetradecenal | (E)-13-Octadecenal |
| (Z)-11-Tetradecen-1-ol | (Z)-13-Octadecen-1-ol |
| (Z)-11-Tetradecenyl acetate | (Z)-13-Octadecenyl acetate |
| (Z)-11-Tetradecenal | (Z)-13-Octadecenal |
| (E)-12-Tetradecenyl acetate | (E)-14-Octadecenal |
| (Z)-12-Tetradecenyl acetate | (E,Z)-2,13-Octadecadien-1-ol |
| (E,E)-2,4-Tetradecadienal | (E,Z)-2,13-Octadecadienyl acetate |
| (E,E)-3,5-Tetradecadienyl acetate | (E,Z)-2,13-Octadecadienal |
| (E,Z)-3,5-Tetradecadienyl acetate | (Z,E)-2,13-Octadecadienyl acetate |
| (Z,E)-3,5-Tetradecadienyl acetate | (Z,Z)-2,13-Octadecadien-1-ol |
| (E,Z)-3,7-Tetradecadienyl acetate | (Z,Z)-2,13-Octadecadienyl acetate |
| (E,Z)-3,8-Tetradecadienyl acetate | (E,E)-3,13-Octadecadienyl acetate |
| (E,Z)-4,9-Tetradecadienyl acetate | (E,Z)-3,13-Octadecadienyl acetate |
| (E,Z)-4,9-Tetradecadienal | (E,Z)-3,13-Octadecadienal |
| (E,Z)-4,10-Tetradecadienyl acetate | (Z,E)-3,13-Octadecadienyl acetate |
| (E,E)-5,8-Tetradecadienal | (Z,Z)-3,13-Octadecadienyl acetate |
| (Z,Z)-5,8-Tetradecadien-1-ol | (Z,Z)-3,13-Octadecadienal |
| (Z,Z)-5,8-Tetradecadienyl acetate | (E,E)-5,9-Octadecadien-1-ol |
| (Z,Z)-5,8-Tetradecadienal | (E,E)-5,9-Octadecadienyl acetate |
| (E,E)-8,10-Tetradecadien-1-ol | (E,E)-9,12-Octadecadien-1-ol |
| (E,E)-8,10-Tetradecadienyl acetate | (Z,Z)-9,12-Octadecadienyl acetate |
| (E,E)-8,10-Tetradecadienal | (Z,Z)-9,12-Octadecadienal |
| (E,Z)-8,10-Tetradecadienyl acetate | (Z,Z)-11,13-Octadecadienal |
| (E,Z)-8,10-Tetradecadienal | (E,E)-11,14-Octadecadienal |
| (Z,E)-8,10-Tetradecadien-1-ol | (Z,Z)-13,15-Octadecadienal |
| (Z,E)-8,10-Tetradecadienyl acetate | (Z,Z,Z)-3,6,9-Octadecatrienyl acetate |
| (Z,Z)-8,10-Tetradecadienal | (E,E,E)-9,12,15-Octadecatrien-1-ol |
| (E,E)-9,11-Tetradecadienyl | (Z,Z,Z)-9,12,15-Octadecatrienyl |
| acetate | acetate |
| (E,Z)-9,11-Tetradecadienyl acetate | (Z,Z,Z)-9,12,15-Octadecatrienal |
| (3E,8Z,11Z)-tetradecatrien-1-yl | (3E,8Z)-tetradecadien-1-yl acetate |
| acetate | |

In embodiments, sex pheromones include the C6-C20 pheromones described in Table 2. In embodiments, the compositions of the present disclosure comprise a sex pheromone described in Table 2. In embodiments, the compositions of the present disclosure comprise a mixture of sex pheromone in Table 2.

TABLE 2
Sex Pheromones of the Present Disclosure

| Name | Structure |
|---|---|
| (Z)-3-hexen-1-ol | 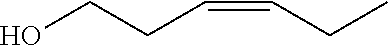 |
| (Z)-3-nonen-1-ol | 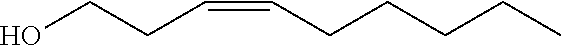 |
| (Z)-5-decen-1-ol | 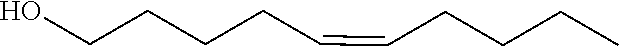 |
| (Z)-5-decenyl acetate | 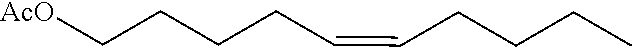 |
| (E)-5-decen-1-ol | 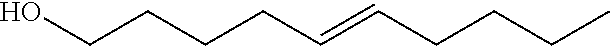 |
| (E)-5-decenyl acetate | 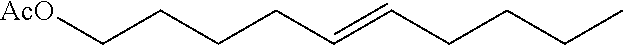 |
| (Z)-7-dodecen-1-ol | 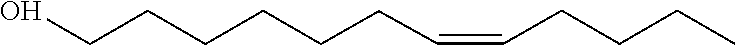 |
| (Z)-7-dodecenyl acetate | 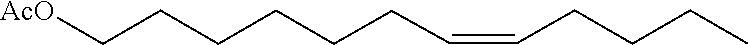 [SMILES: CCCC/C=C\CCCCCCOC(C)=O] |
| (E)-8-dodecen-1-ol | 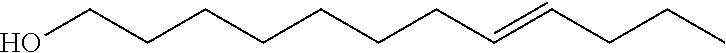 |
| (E)-8-dodecenyl acetate | 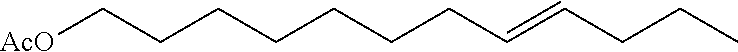 [SMILES: CCC/C=C/CCCCCCCOC(C)=O] |
| (Z)-8-dodecen-1-ol | 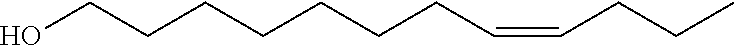 |
| (Z)-8-dodecenyl acetate | 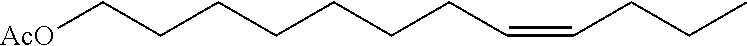 [SMILES: CCC/C=C\CCCCCCCOC(C)=O] |
| (Z)-9-dodecen-1-ol | 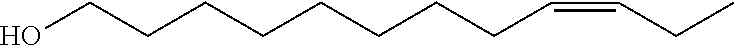 |
| (Z)-9-dodecenyl acetate | 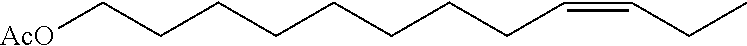 [SMILES: CC/C=C\CCCCCCCCOC(C)=O] |
| (Z)-9-Octadecenal | 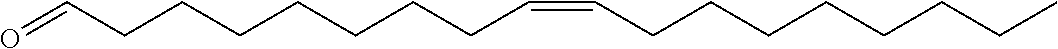 [SMILES: CCCCCCCC/C=C\CCCCCCCC=O] |
| (E,E)-8,10-dodecadien-1-ol | 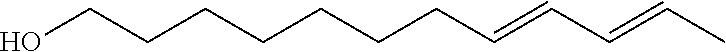 |
| (7E,9Z)-dodecadienyl acetate | 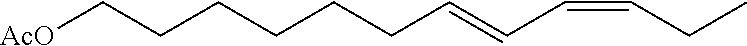 [SMILES: CC/C=C\C=C\CCCCCCOC(C)=O] |
| (Z)-9-tetradecen-1-ol | 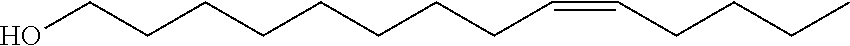 |
| (Z)-9-tetradecenyl acetate | 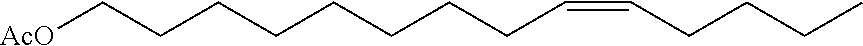 [SMILES: CCCC/C=C\CCCCCCCCOC(C)=O] |
| (Z)-11-tetradecen-1-ol | 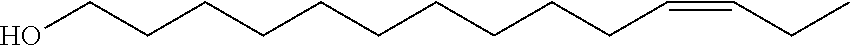 |
| (Z)-11-tetradecenyl acetate | 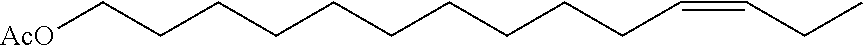 [SMILES: CC/C=C\CCCCCCCCCCOC(C)=O] |
| (E)-11-tetradecen-1-ol | 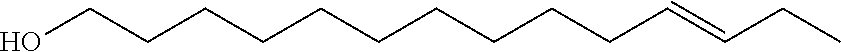 |
| (E)-11-tetradecenyl acetate | 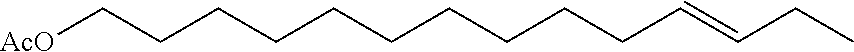 [SMILES: CC/C=C/CCCCCCCCCCOC(C)=O] |
| (Z)-7-hexadecen-1-ol | 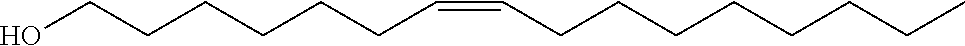 [SMILES: CCCCCCCC/C=C\CCCCCCO] |
| (Z)-7-hexadecenal | 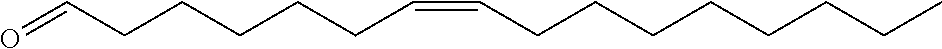 [SMILES: CCCCCCCC/C=C\CCCCCC=O] |
| (Z)-9-hexadecen-1-ol | 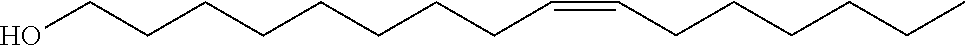 [SMILES: CCCCCC/C=C\CCCCCCCCO] |
| (Z)-9-hexadecenal | 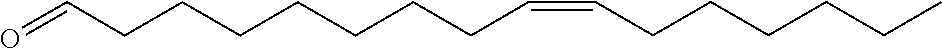 [SMILES: CCCCCC/C=C\CCCCCCCC=O] |
| (Z)-9-hexadecenyl acetate | 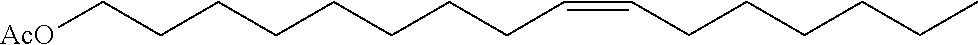 [SMILES: CCCCCC/C=C\CCCCCCCCOC(C)=O] |
| (Z)-11-hexadecen-1-ol | 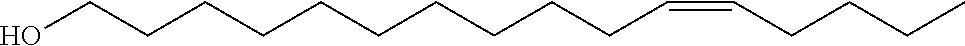 [SMILES: CCCC/C=C\CCCCCCCCCCO] |
| (Z)-11-hexadecenal | 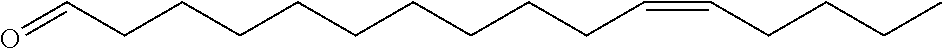 [SMILES: CCCC/C=C\CCCCCCCCCC=O] |
| (Z)-11-hexadecenyl acetate | 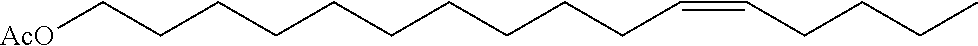 [SMILES: CCCC/C=C\CCCCCCCCCCOC(C)=O] |
| (Z,Z)-11,13-hexadecadienal | 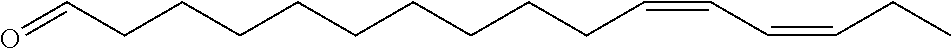 [SMILES: CC/C=C\C=C/CCCCCCCCCC=O] |
| (Z,Z)-11,13-hexadecadien-1-ol | 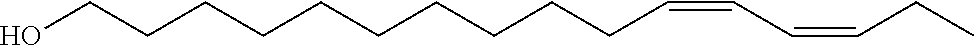 [SMILES: CC/C=C\C=C/CCCCCCCCCCO] |
| (11Z,13E)- hexadecadien-1-ol | 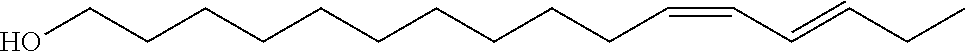 [SMILES: CC/C=C/C=C\CCCCCCCCCCO] |
| (9Z,11E)-hexadecadienal | 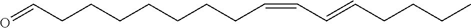 [SMILES: CCCC/C=C/C=C\CCCCCCCC=O] |
| (Z)-13-octadecen-1-ol | 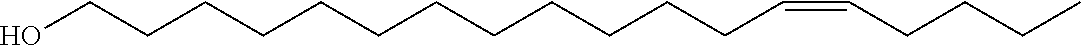 [SMILES: CCCC/C=C\CCCCCCCCCCCCO] |
| (Z)-13-octadecenal | 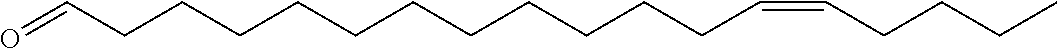 [SMILES: CCCC/C=C\CCCCCCCCCCCC=O] |
| (Z,Z,Z,Z,Z)-3,6,9,12,15- tricosapentaene | 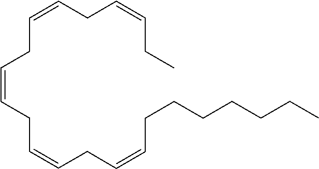 [SMILES: CC/C=C\C/C=C\C/C=C\C/C=C\C/C=C\CCCCCCC] |

In embodiments, the pheromone in a composition of the present disclosure comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof.

In embodiments, the pheromone in a composition of the present disclosure comprises (Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof.

In embodiments, the pheromone in a composition of the present disclosure comprises (Z)-9-Tetradecenyl Acetate (Z9-14Ac), (Z)-11-Hexadecenyl Acetate (Z11-16Ac), and mixtures thereof.

### Pests

In some aspects, the present disclosure provides methods for controlling a population of one or more pests in an area (such as a field) where the agrochemical compositions of the present disclosure are applied. Persons skilled in the art can select the type and amount of an active ingredient, or mixture of active ingredients (such as a pheromone), that, when used in an agrochemical composition of the present disclosure, is effective for a particular pest (such Spodoptera frugiperda (fall armyworm)). The following are non-limiting examples of pests that may be controlled using the agrochemical compositions of the present disclosure.

In embodiments, the pests comprise one or more insects.

In embodiments, the pest comprises pests of the Phylum Nematoda. In embodiments, the pest comprises pests of the Phylum Arthropoda. In embodiments, the pest comprises pests of the Subphylum Chelicerata. In embodiments, the pests comprise pets of the Class Arachnida. In embodiments, the pests comprise pests of Subphylum Myriapoda. In embodiments, the pests comprise pests of the Class Symphyla. In embodiments, the pests comprise pests of the Subphylum Hexapoda. In embodiments, the pests comprise pests of the Class Insecta.

In embodiments, the pest comprises Coleoptera (beetles). A non-exhaustive list of these pests includes, but is not limited to, Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp., Cerotoma spp. (chrysomeids), Cerotoma trifurcate (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys fuscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (European chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle), and Zabrus tenebioides.

In embodiments, the pest comprises Dictyoptera (cockroaches). A non-exhaustive list of these pests includes, but is not limited to, Blattella germanica (German cockroach), Blatta orientalis (oriental cockroach), Parcoblatta pennylvanica, Periplaneta americana (American cockroach), Periplaneta australoasiae (Australian cockroach), Periplaneta brunnea (brown cockroach), Periplaneta fuliginosa (smokybrown cockroach), Pyncoselus suninamensis (Surinam cockroach), and Supella longipalpa (brownbanded cockroach).

In embodiments, the pest comprises Diptera (true flies). A non-exhaustive list of these pests includes, but is not limited to, Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cochliomyia spp. (screwworms), Contarinia spp. (gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (frit fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies), and Tipula spp. (crane flies).

In embodiments, the pest comprises Hemiptera (true bugs). A non-exhaustive list of these pests includes, but is not limited to, Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea, and Triatoma spp. (bloodsucking conenose bugs/kissing bugs).

In embodiments, the pest comprises Homoptera (aphids, scales, whiteflies, leafhoppers). A non-exhaustive list of these pests includes, but is not limited to, Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantia (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchase (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphin (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale), and Zulia entreriana.

In embodiments, the pest comprises Hymenoptera (ants, wasps, and bees). A non-exhaustive list of these pests includes, but is not limited to, Acromyrrmex spp., Athalia rosae, Atta spp. (leafcutting ants), Camponotus spp. (carpenter ants), Diprion spp. (sawflies), Formica spp. (ants), Iridomyrmex humilis (Argentine ant), Monomorium ssp., Monomorium minimum (little black ant), Monomorium pharaonic (Pharaoh ant), Neodiprion spp. (sawflies), Pogonomyrmex spp. (harvester ants), Polistes spp. (paper wasps), Solenopsis spp. (fire ants), Tapoinoma sessile (odorous house ant), Tetranomorium spp. (pavement ants), Vespula spp. (yellow jackets), and Xylocopa spp. (carpenter bees).

In embodiments, the pest comprises Isoptera (termites). A non-exhaustive list of these pests includes, but is not limited to, Coptotermes spp., Coptotermes curvignathus, Coptotermes frenchii, Coptotermes formosanus (Formosan subterranean termite), Cornitermes spp. (nasute termites), Cryptotermes spp. (drywood termites), Heterotermes spp. (desert subterranean termites), Heterotermes aureus, Kalotermes spp. (drywood termites), Incistitermes spp. (drywood termites), Macrotermes spp. (fungus growing termites), Marginitermes spp. (drywood termites), Microcerotermes spp. (harvester termites), Microtermes obesi, Procornitermes spp., Reticulitermes spp. (subterranean termites), Reticulitermes banyulensis, Reticulitermes grassei, Reticulitermes flavipes (eastern subterranean termite), Reticulitermes hageni, Reticulitermes hesperus (western subterranean termite), Reticulitermes santonensis, Reticulitermes speratus, Reticulitermes tibialis, Reticulitermes virginicus, Schedorhinotermes spp., and Zootermopsis spp. (rotten-wood termites).

In embodiments, the pest comprises Lepidoptera (moths and butterflies). A non-exhaustive list of these pests includes, but is not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruit tree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leaf perforator), Caloptilia spp. (leaf miners), Capua reticulana, Carposina niponensis (peach fruit moth), Chilo spp., Chlumetia transversa (mango shoot borer), Choristoneura rosaceana (oblique banded leaf roller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwestern corn borer), Earias spp. (bollworms), Earias insulata (Egyptian bollworm), Earias vitelli (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobacco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicate (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparanal (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabs, Plodia interpunctella (Indian meal moth), Plutella xylostella (diamondback moth), Polychrosis viteana (grape berry moth), Prays endocarps, Prays oleae (olive moth), Pseudaletia spp. (noctuid moths), Pseudaletia unipunctata (armyworm), Pseudoplusia includens (soybean looper), Rachiplusia nu, Scirpophaga incertulas (yellow stemborer), Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera frugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer), and Zeuzera pyrina (leopard moth).

In embodiments, the pest comprises Mallophaga (chewing lice). A non-exhaustive list of these pests includes, but is not limited to, Bovicola ovis (sheep biting louse), Menacanthus stramineus (chicken body louse), and Menopon gallinea (common hen louse).

In embodiments, the pest comprises Orthoptera (grasshoppers, locusts, and crickets). A non-exhaustive list of these pests includes, but is not limited to, Anabrus simplex (Mormon cricket), Gryllotalpidae (mole crickets), Locusta migratoria, Melanoplus spp. (grasshoppers), Microcentrum retinerve (angular winged katydid), Pterophylla spp. (katydids), chistocerca gregaria, Scudderia furcate (fork tailed bush katydid), and Valanga nigricorni.

In embodiments, the pest comprises Phthiraptera (sucking lice). A non-exhaustive list of these pests includes, but is not limited to, Haematopinus spp. (cattle and hog lice), Linognathus ovillus (sheep louse), Pediculus humanus capitis (human body louse), Pediculus humanus (human body lice), and Pthirus pubis (crab louse).

In embodiments, the pest comprises Siphonaptera (fleas). A non-exhaustive list of these pests includes, but is not limited to, Ctenocephalides canis (dog flea), Ctenocephalides felis (cat flea), and Pulex irritans (human flea).

In embodiments, the pest comprises Thysanoptera (thrips). A non-exhaustive list of these pests includes, but is not limited to, Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis, and Thrips spp.

In embodiments, the pest comprises Thysanura (bristletails). A non-exhaustive list of these pests includes, but is not limited to, Lepisma spp. (silverfish) and Thermobia spp. (firebrats).

In embodiments, the pest comprises Acarina (mites and ticks). A non-exhaustive list of these pests includes, but is not limited to, Acarapsis woodi (tracheal mite of honeybees), Acarus spp. (food mites), Acarus siro (grain mite), Aceria mangiferae (mango bud mite), Aculops spp., Aculops lycopersici (tomato russet mite), Aculops pelekasi, Aculus pelekassi, Aculus schlechtendali (apple rust mite), Amblyomma Americanum (lone star tick), Boophilus spp. (ticks), Brevipalpus obovatus (privet mite), Brevipalpus phoenicis (red and black flat mite), Demodex spp. (mange mites), Dermacentor spp. (hard ticks), Dermacentor variabilis (American dog tick), Dermatophagoides pteronyssinus (house dust mite), Eotetranycus spp., Eotetranychus carpini (yellow spider mite), Epitimerus spp., Eriophyes spp., Ixodes spp. (ticks), Metatetranycus spp., Notoedres cati, Oligonychus spp., Oligonychus coffee, Oligonychus ilicus (southern red mite), Panonychus spp., Panonychus citri (citrus red mite), Panonychus ulmi (European red mite), Phyllocoptruta oleivora (citrus rust mite), Polyphagotarsonemun latus (broad mite), Rhipicephalus sanguineus (brown dog tick), Rhizoglyphus spp. (bulb mites), Sarcoptes scabiei (itch mite), Tegolophus perseaflorae, Tetranychus spp., Tetranychus urticae (two-spotted spider mite), and Varroa destructor (honey bee mite).

In embodiments, the pest comprises Nematoda (nematodes). A non-exhaustive list of these pests includes, but is not limited to, Aphelenchoides spp. (bud and leaf & pine wood nematodes), Belonolaimus spp. (sting nematodes), Criconemella spp. (ring nematodes), Dirofilaria immitis (dog heartworm), Ditylenchus spp. (stem and bulb nematodes), Heterodera spp. (cyst nematodes), Heterodera zeae (corn cyst nematode), Hirschmanniella spp. (root nematodes), Hoplolaimus spp. (lance nematodes), Meloidogyne spp. (root knot nematodes), Meloidogyne incognita (root knot nematode), Onchocerca volvulus (hook-tail worm), Pratylenchus spp. (lesion nematodes), Radopholus spp. (burrowing nematodes), and Rotylenchus reniformis (kidney-shaped nematode).

In embodiments, the pest comprises Symphyla (symphylans). A non-exhaustive list of these pests includes, but is not limited to, Scutigerella immaculata.

### Agrochemical Compositions

In one aspect, the present disclosure provides controlled-release agrochemical compositions.

In embodiments, the compositions of the present disclosure provide slow release of an active ingredient into the atmosphere, and/or so as to be protected from degradation following release. In embodiments, the compositions of the present disclosure are biodegradable.

In embodiments, a composition of the present disclosure comprises: (a) a matrix; (b) an active ingredient composition contained within the matrix. In embodiments, the composition further comprises (c) a filler contained within the matrix.

In embodiments, the matrix comprises a binder. In embodiments, the binder comprises one or more polymers. In embodiments, the binder is a biodegradable polymer.

In embodiments, the binder comprises one or more biodegradable polymers. In embodiments, the binder is polycaprolactone (PCL), poly(butylene adipate-co-terephthalate) (PBAT), polybutylene succinate (PBS), polyhydroxyalkanoate (PHA), polylactic acid (PLA), or mixtures thereof. In embodiments, the biodegradable polymer is PCL. In embodiments, the biodegradable polymer is PLA.

In embodiments, the binder comprises one or more non-biodegradable polymers. In embodiments, the non-biodegradable polymer is low density polyethylene (LDPE), ethylene-vinyl acetate (EVA), high density polyethylene (HDPE), polyvinyl acetate (PVA), or mixtures thereof.

In embodiments, a composition of the present disclosure comprises from about 10 wt % to about 98 wt % of a binder, e.g., about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, including all values and ranges there between.

In embodiments, the composition comprises from about 10 wt % to about 20 wt %, about 20 wt % to about 40 wt %, about 20 wt % to about 80 wt %, about 30 wt % to about 50 wt %, about 30 wt % to about 70 wt %, about 40 wt % to about 80 wt %, about 40 wt % to about 90 wt %, about 50 wt % to about 70 wt %, about 50 wt % to about 80 wt %, about 50 wt % to about 90 wt %, about 60 wt % to about 80 wt %, about 60 wt % to about 90 wt %, about 70 wt % to about 90 wt %, about 80 wt % to about 90 wt %, about 80 wt % to about 98 wt %, about 90 wt % to about 98 wt % of a binder.

In embodiments, the composition comprises about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt % of a binder.

In embodiments, the compositions of the present disclosure comprise a filler. In embodiments, the filler is contained within the matrix. In embodiments, the matrix comprises a binder and the filler is contained within the binder.

In embodiments, the filler is clay, a zeolite, talcum, shredded hay, cotton, cork, hemp, wood chips, wood dust, wood excelsior, microcrystalline cellulose, paper pulp, kaolin, calcined kaolin, chitosan, or mixture thereof. In embodiments, the clay is organoclay.

In embodiments, the filler comprises microcrystalline cellulose. In embodiments, the filler comprises kaolin. In embodiments, the filler comprises calcined kaolin.

In embodiments, the filler comprises a biomass from a fermentation.

In embodiments, the filler comprises an active filler (e.g., a filler capable of retaining the semiochemical).

In embodiments, a composition of the present disclosure comprises from about 1 wt % to about 98 wt % of a filler, e.g., about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, including all values and ranges there between.

In embodiments, the composition comprises from about 1 wt % to about 80 wt %, about 1 wt % to about 90 wt %, about 1 wt % to about 98 wt %, about 5 wt % to about 80 wt %, about 10 wt % to about 20 wt %, about 20 wt % to about 40 wt %, about 20 wt % to about 80 wt %, about 30 wt % to about 50 wt %, about 30 wt % to about 70 wt %, about 40 wt % to about 80 wt %, about 40 wt % to about 90 wt %, about 50 wt % to about 70 wt %, about 50 wt % to about 80 wt %, about 50 wt % to about 90 wt %, about 60 wt % to about 80 wt %, about 60 wt % to about 90 wt %, about 70 wt % to about 90 wt %, about 80 wt % to about 90 wt %, about 80 wt % to about 98 wt %, about 90 wt % to about 98 wt % of a filler.

In embodiments, the composition comprises about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt % of a filler.

In embodiments, the composition further comprises an additive, an antioxidant, a UV-blocking agent, an anticaking agent, or mixtures thereof.

In embodiments, the composition further comprises an additive. In embodiments, the additive is a dye, reflectant, inorganic salt, organic salt, or mixtures thereof.

In embodiments, the composition further comprises an antioxidant. In embodiments, the antioxidant is butylated hydroxytoluene (BHT), tert-butylhydroquinone (TBHQ), and mixtures thereof.

In embodiments, a composition of the present disclosure comprises from about 0.1 wt % to about 1 wt % of an antioxidant, e.g., about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, including all values and ranges there between.

In embodiments, the composition comprises about 0.1 wt % to about 0.5 wt %, about 0.2 wt % to about 0.5 wt %, about 0.3 wt % to about 0.5 wt %, about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt % of an antioxidant.

In embodiments, the composition comprises about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % of an antioxidant.

In embodiments, the composition further comprises a UV-blocking agent. In embodiments, the UV-blocking agent is methyl cinnamate, iron oxides, carbon black, octabenzone, or mixtures thereof.

In embodiments, the composition further comprises an anticaking agent. In embodiments, the anticaking agent is charcoal, amorphous silica, fumed silica, or mixtures thereof.

In embodiments, a composition of the present disclosure comprises from about 0 wt % to about 2 wt % of an anticaking agent, e.g., about 0 wt %, about 0.5 wt %, about 1 wt %, about 1.5 wt %, or about 2 wt %, including all values and ranges there between.

In embodiments, the composition comprises about 0 wt % to about 0.5 wt %, about 0 wt % to about 1 wt %, about 0 wt % to about 1.5 wt %, about 0 wt % to about 2 wt %, about 0.5 wt % to about 1 wt %, about 0.5 wt % to about 1.5 wt %, about 0.5 wt % to about 2 wt %, about 1 wt % to about 1.5 wt %, about 1 wt % to about 2 wt %, or about 1.5 wt % to about 2 wt % of an anticaking agent.

In embodiments, the composition comprises about 0 wt %, about 0.5 wt %, about 1 wt %, about 1.5 wt %, or about 2 wt % of an anticaking agent.

In embodiments, a composition of the present disclosure comprises from about 1 wt % to about 70 wt % of an active ingredient composition comprising one or more active ingredients, e.g., about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, or about 70 wt %, including all values and ranges therebetween.

In embodiments, the composition comprises from about 1 wt % to about 70 wt %, about 1 wt % to about 50 wt %, about 10 wt % to about 60 wt %, about 15 wt % to about 70 wt %, about 20 wt % to about 60 wt %, about 25 wt % to about 70 wt %, about 30 wt % to about 50 wt %, about 50 wt % to about 70 wt % of an active ingredient composition.

In embodiments, the composition comprises about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, or about 70 wt % of an active ingredient composition. In embodiments, the active ingredient composition comprises from about 10 wt % to about 98 wt % of one or more active ingredients. In embodiments, the active ingredient composition comprises from about 10 wt % to about 20 wt %, about 20 wt % to about 40 wt %, about 20 wt % to about 80 wt %, about 30 wt % to about 50 wt %, about 30 wt % to about 70 wt %, about 40 wt % to about 80 wt %, about 40 wt % to about 90 wt %, about 50 wt % to about 70 wt %, about 50 wt % to about 80 wt %, about 50 wt % to about 90 wt %, about 60 wt % to about 80 wt %, about 60 wt % to about 90 wt %, about 70 wt % to about 90 wt %, about 80 wt % to about 90 wt %, about 80 wt % to about 98 wt %, about 90 wt % to about 98 wt % of one or more active ingredients. In embodiments, the active ingredient composition comprises about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt % of one or more active ingredients.

In embodiments, a composition of the present disclosure comprises from about 1 mg to about 5 mg of an active ingredient composition. In embodiments, the composition comprises from about 1 mg to about 2 mg, about 1 mg to about 3 mg, about 1 mg to about 4 mg, about 1 mg to about 5 mg, about 2 mg to about 3 mg, about 2 mg to about 4 mg, about 2 mg to about 5 mg, about 3 mg to about 4 mg, about 3 mg to about 5 mg, or about 4 mg to about 5 mg of an active ingredient composition. In embodiments, the composition comprises about 1 mg, about 1.5 mg, about 2 mg, about 2.5 mg, about 3 mg, about 3.5 mg, about 4 mg, about 4.5 mg, or about 5 mg of an active ingredient composition.

In embodiments, a composition of the present disclosure comprises an active ingredient composition and a binder, in which a weight ratio of the active ingredient composition and binder is 99:1 to 60:40; 20:80 to 80:20, or 1:1.

In embodiments, a composition of the present disclosure comprises an active ingredient composition and a filler, in which a weight ratio of the filler to active ingredient composition is 99:1 to 60:40, 20:80 to 80:20, or 1:1.

In embodiments, the active ingredient composition is a semiochemical composition comprising one or more semiochemicals. In embodiments, the semiochemical composition comprises pheromones. In embodiments, the semiochemical composition comprises one or more pheromones of Table 1 and Table 2. In embodiments, the semiochemical composition comprises Z7-12Ac, Z8-12Ac, Z9-12Ac, E7Z9-12Ac, Z11-14Ac, E5-10Ac, E8E10-10Ac, Z11-16Ac, and mixtures thereof. In embodiments, the semiochemical composition comprises Z9-16Ald, Z11-16Ald, Z13-18Ald, Z9-18Ald, and mixtures thereof. In embodiments, the semiochemical composition comprises Z9-14Ac, Z11-16Ac, and mixtures thereof. In embodiments, the semiochemical comprises Z9-14Ac and Z11-16Ac.

In embodiments, the semiochemical composition comprises about 75 wt % of Z9-16A1, about 10 wt % Z11-16Ald, about 8 wt % of Z13-18Ald, and about 7 wt % of Z9-18Ald.

In embodiments, the semiochemical composition comprises 87 wt % of Z9-14Ac and about 13 wt % of Z11-16Ac.

In embodiments, the active ingredient composition is miscible in the matrix. In embodiments, the active ingredient composition is immiscible in the matrix. In embodiments, the semiochemical composition is miscible in the binder. In embodiments, the semiochemical composition is immiscible in the binder. In embodiments, the active ingredient composition is miscible in the binder and the binder comprises PCL. In embodiments, the active ingredient composition is immiscible in the binder and the binder comprises PLA.

In embodiments, the composition comprises PCL and calcined kaolin. In embodiments, the composition comprises PLA and calcined kaolin. In embodiments, the composition comprises EVA and calcined kaolin. In embodiments, the composition comprises PBS and calcined kaolin. In embodiments, the composition comprises PHA and calcined kaolin.

In embodiments, the composition comprises PCL and microcrystalline cellulose. In embodiments, the composition comprises PLA and microcrystalline cellulose. In embodiments, the composition comprises EVA and calcined kaolin. In embodiments, the composition comprises PBS and microcrystalline cellulose. In embodiments, the composition comprises PHA and microcrystalline cellulose.

In embodiments, a composition of the present disclosure comprises active ingredient droplets. In embodiments, the droplets are evenly distributed throughout the composition. In embodiments, a mean dimension of the droplet is from about 0.5 microns to about 5 microns. In embodiments, a mean dimension of the droplet is from about 0.5 microns to about 1 micron, about 0.5 micron to about 2 microns, about 0.5 microns to about 3 microns, about 0.5 microns to about 4 microns, about 0.5 microns to about 5 microns, about 1 micron to about 2 microns, about 1 micron to about 3 microns, about 1 micron to about 4 microns, about 1 micron to about 5 microns, about 2 microns to about 3 microns, about 2 microns about 4 microns, about 2 microns to about 5 microns, about 3 microns to about 4 microns, about 3 microns to about 5 microns, or about 4 microns to about 5 microns. In embodiments, the droplets have a mean dimension of about 0.5 microns, about 1 micron, about 1.5 micron, about 2 microns, about 2.5 microns, about 3 microns, about 3.5 microns, about 4 microns, about 4.5 microns, or about 5 microns.

In embodiments, a composition of the present disclosure is a granule. In embodiments, a composition of the present disclosure is a flake. In embodiments, a composition of the present disclosure is a dispenser. In embodiments, a composition of the present disclosure is a string.

In embodiments, a surface area of the composition (e.g., granule, flake, or dispenser) is from about 1 cm² to about 150 cm². In embodiments, a surface area of the composition is from about 1 cm² to about 10 cm², about 1 cm² to about 40 cm², about 1 cm² to about 80 cm², about 1 cm² to about 120 cm², about 1 cm² to about 140 cm², about 10 cm² to about 50 cm², about 10 cm² to about 90 cm², about 10 cm² to about 130 cm², about 10 cm² to about 150 cm², about 20 cm² to about 60 cm², about 20 cm² to about 100 cm², about 20 cm² to about 120 cm², about 20 cm² to about 150 cm², about 30 cm² to about 50 cm², about 30 cm² to about 80 cm², about 30 cm² to about 120 cm², about 40 cm² to about 60 cm², about 40 cm² to about 100 cm², about 40 cm² to about 150 cm², about 50 cm² to about 90 cm², about 50 cm² to about 120 cm², about 50 cm² to about 150 cm², about 60 cm² to about 90 cm², about 60 cm² to about 120 cm², about 60 cm² to about 150 cm², about 70 cm² to about 90 cm², about 70 cm² to about 130 cm², about 70 cm² to about 140 cm², about 80 cm² to about 100 cm², about 80 cm² to about 120 cm², about 90 cm² to about 130 cm², about 100 cm² to about 130 cm², or about 100 cm² to about 150 cm². In embodiments, a surface area of the composition is about 1 cm², about 10 cm², about 20 cm², about 30 cm², about 40 cm², about 50 cm², about 60 cm², about 70 cm², about 80 cm², about 90 cm², about 100 cm², about 110 cm², about 120 cm², about 130 cm², about 140 cm², or about 150 cm².

In embodiments, the composition is a granule. In embodiments, the granule is a cylinder, cube, sphere, irregular 3d object, and mixtures thereof.

In embodiments, a mean dimension of the granule is from about 0.1 mm to about 10 mm. In embodiments, a mean dimension of the granule is from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, a mean volume of the granule is from about 0.001 mm³ to about 1000 mm³. In embodiments, a mean volume of the granule is from about 0.001 mm³ to about 10 mm³, about 0.001 mm³ to about 100 mm³, about 0.001 mm³ to about 1000 mm³, about 0.01 mm³ to about 10 mm³, about 0.01 mm³ to about 100 mm³, about 0.01 mm³ to about 1000 mm³, about 1 mm³ to about 10 mm³, about 1 mm³ to about 100 mm³, about 1 mm³ to about 1000 mm³, about 10 mm³ to about 100 mm³, about 10 mm³ to about 1000 mm³, about 50 mm³ to about 100 mm³, about 50 mm³ to about 1000 mm³, or about 500 mm³ to about 1000 mm³. In embodiments, a mean volume of the granule is about 0.001 mm³, about 0.01 mm³, about 0.1 mm³, about 1 mm³, about 10 mm³, about 100 mm³, or about 1000 mm³.

In embodiments, the granule is a cylinder having a height from about 0.1 mm to about 10 mm. In embodiments, the granule is a cylinder having a height from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, the granule is a cylinder having a circumference from about 0.1 mm to about 10 mm. In embodiments, the granule is a cylinder having a circumference from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, the granule is a cylinder having a height and a circumference of about 0.1 mm, about 0.5 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In embodiments, the composition is a dispenser. In embodiments, the dispenser is in the shape of a cylindrical disc. In embodiments, the dispenser is in the shape of a rectangular prism.

In embodiments, a thickness of the dispenser is from about 0.1 mm to about 10 mm. In embodiments, a thickness of the dispenser is from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm. In embodiments, a thickness of the dispenser is about 0.1 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In embodiments, a height of the dispenser is from about 20 mm to about 80 mm. In embodiments, a height of the dispenser is from about 20 mm to about 30 mm, about 20 mm to about 40 mm, about 20 mm to about 50 mm, about 20 mm to about 60 mm, about 20 mm to about 70 mm, about 20 mm to about 80 mm, about 30 mm to about 40 mm, about 30 mm to about 50 mm, about 30 mm to about 60 mm, about 30 mm to about 70 mm, about 30 mm to about 80 mm, about 40 mm to about 50 mm, about 40 mm to about 60 mm, about 40 mm to about 70 mm, about 40 mm to about 80 mm, about 50 mm to about 60 mm, about 50 mm to about 70 mm, about 50 mm to about 80 mm, about 60 mm to about 70 mm, about 60 mm to about 80 mm, about 70 mm to about 80 mm. In embodiments, a height of the dispenser is about 20 mm, about 25 mm, about 30 mm, about 35 mm, about 40 mm, about 45 mm, about 50 mm, about 55 mm, about 60 mm, about 65 mm, about 70 mm, about 75 mm, or about 80 mm.

In embodiments, a length of the dispenser is from about 50 mm to about 150 mm. In embodiments, a length of the dispenser is from about 50 mm to about 60 mm, about 50 mm to about 70 mm, about 50 mm to about 80 mm, about 50 mm to about 80 mm, about 50 mm to about 90 mm, about 50 mm to about 100 mm, about 50 mm to about 110 mm, about 50 mm to about 120 mm, about 50 mm to about 130 mm, about 50 mm to about 140 mm, about 50 mm to about 150 mm, about 60 mm to about 70 mm, about 60 mm to about 80 mm, about 60 mm to about 90 mm, about 60 mm to about 100 mm, about 60 mm to about 110 mm, about 60 mm to about 120 mm, about 60 mm to about 130 mm, about 60 mm to about 140 mm, about 60 mm to about 150 mm, about 70 mm to about 80 mm, about 70 mm to about 90 mm, about 70 mm to about 100 mm, about 70 mm to about 110 mm, about 70 mm to about 120 mm, about 70 mm to about 130 mm, about 70 mm to about 140 mm, about 70 mm to about 150 mm, about 80 mm to about 90 mm, about 80 mm to about 100 mm, about 80 mm to about 110 mm, about 80 mm to about 120 mm, about 80 mm to about 130 mm, about 80 mm to about 140 mm, about 80 mm to about 150 mm, about 90 mm to about 100 mm, about 90 mm to about 110 mm, about 90 mm to about 120 mm, about 90 mm to about 130 mm, about 90 mm to about 140 mm, about 90 mm to about 150 mm, about 100 mm to about 110 mm, about 100 mm to about 120 mm, about 100 mm to about 130 mm, about 100 mm to about 140 mm, about 100 mm to about 150 mm, about 110 mm to about 120 mm, about 110 mm to about 130 mm, about 110 mm to about 140 mm, about 110 mm to about 150 mm, about 120 mm to about 130 mm, about 120 mm to about 140 mm, about 120 mm to about 150 mm, about 130 mm to about 140 mm, about 130 mm to about 150 mm, or about 140 mm to about 150 mm. In embodiments, a length of the dispenser is about 50 mm, about 60 mm, about 70 mm, about 80 mm, about 90 mm, about 100 mm, about 110 mm, about 120 mm, about 130 mm, about 140 mm, or about 150 mm.

In embodiments, the composition is a flake. In embodiments, a length of the flake is from about 1 mm to about 5 mm. In embodiments, a length of the flake is from about 1 mm to about 2 mm, about 1 mm to about 3 mm, about 1 mm to about 4 mm, about 1 mm to about 5 mm, about 2 mm to about 3 mm, about 2 mm to about 4 mm, about 2 mm to about 5 mm, about 3 mm to about 4 mm, about 3 mm to about 5 mm, or about 4 mm to about 5 mm. In embodiments, a length of a flake is of about 1 mm, about 2 mm, about 3 mm, about 4 mm, or about 5 mm.

In embodiments, a thickness of the flake is from about 0.5 mm to about 2 mm. In embodiments, a thickness of the flake is from about 0.5 mm to about 1 mm, about 0.5 mm to about 1.5 mm, about 0.5 mm to about 2 mm, about 1 mm to about 1.5 mm, about 1 mm to about 2 mm, or about 1.5 mm to about 2 mm. In embodiments, a thickness of the flakes is about 0.5 mm, about 1 mm, about 1.5 mm, or about 2 mm.

In embodiments, a height of a flake is from about 1 mm to about 5 mm. In embodiments, a height of the flake is from about 1 mm to about 2 mm, about 1 mm to about 3 mm, about 1 mm to about 4 mm, about 1 mm to about 5 mm, about 2 mm to about 3 mm, about 2 mm to about 4 mm, about 2 mm to about 5 mm, about 3 mm to about 4 mm, about 3 mm to about 5 mm, or about 4 mm to about 5 mm. In embodiments, a height of the flake is about 1 mm, about 2 mm, about 3 mm, about 4 mm, or about 5 mm.

In embodiments, the composition is a string. In embodiments, a circumference from about 0.1 mm to about 10 mm. In embodiments, the granule is a cylinder having a circumference of the string is from about 0.1 mm to about 10 mm, about 0.1 mm to about 9 mm, about 0.1 mm to about 8 mm, about 0.1 mm to about 7 mm, about 0.1 mm to about 6 mm, about 0.1 mm to about 5 mm, about 0.1 mm to about 4 mm, about 0.1 mm to about 3 mm, about 0.1 mm to about 2 mm, about 0.1 mm to about 1 mm, about 1 mm to about 2 mm, about 1 mm to about 3 mm, about 1 mm to about 4 mm, about 1 mm to about 5 mm, about 1 mm to about 6 mm, about 1 mm to about 7 mm, about 1 mm to about 8 mm, about 1 mm to about 9 mm, about 1 mm to about 10 mm, about 2 mm to about 3 mm, about 2 mm to about 4 mm, about 2 mm to about 5 mm, about 2 mm to about 6 mm, about 2 mm to about 7 mm, about 2 mm to about 8 mm, about 2 mm to about 9 mm, about 2 mm to about 10 mm, about 3 mm to about 4 mm, about 3 mm to about 5 mm, about 3 mm to about 6 mm, about 3 mm to about 7 mm, about 3 mm to about 8 mm, about 3 mm to about 9 mm, about 3 mm to about 10 mm, about 4 mm to about 5 mm, about 4 mm to about 6 mm, about 4 mm to about 7 mm, about 4 mm to about 8 mm, about 4 mm to about 9 mm, about 4 mm to about 10 mm, about 5 mm to about 6 mm, about 5 mm to about 7 mm, about 5 mm to about 8 mm, to about 5 mm to about 9 mm, about 5 mm to about 10 mm, about 6 mm to about 7 mm, about 6 mm to about 8 mm, about 6 mm to about 9 mm, about 6 mm to about 10 mm, about 7 mm to about 8 mm, to about 7 mm to about 9 mm, about 7 mm to about 10 mm, about 8 mm to about 9 mm, about 8 mm to about 10 mm, or about 9 mm to about 10 mm.

In embodiments, a length of the string is from about 1 mm to about 10 mm. In embodiments, a height of the string is from about 1 mm to about 2 mm, about 1 mm to about 3 mm, about 1 mm to about 4 mm, about 1 mm to about 5 mm, about 2 mm to about 3 mm, about 2 mm to about 4 mm, about 2 mm to about 5 mm, about 3 mm to about 4 mm, about 3 mm to about 5 mm, about 4 mm to about 5 mm, about 1 mm to about 6 mm, about 3 mm to about 8 mm, about 5 mm to about 10. In embodiments, a length of the string is about 1 mm, about 2 mm, about 3 mm, about 4 mm, about 5 mm, about 6 mm, about 7 mm, about 8 mm, about 9 mm, or about 10 mm.

In embodiments, a composition of the present disclosure releases from about 10 mg to about 50 mg of the active ingredient per day after installation in a field. In embodiments, the composition releases from about 10 mg to about 15 mg, about 10 mg to about 20 mg, about 10 mg to about 30 mg, about 10 mg to about 40 mg, about 10 mg to about 50 mg, about 20 mg to about 30 mg, about 20 mg to about 40 mg, about 20 mg to about 50 mg, about 30 mg to about 40 mg, about 30 mg to about 50 mg, or about 40 mg to about 50 mg of the active ingredient per day after installation in a field. In embodiments, the active ingredient releases about 10 mg, about 15 mg, about 20 mg, about 25 mg, about 30 mg, about 35 mg, about 40 mg, about 45 mg, or about 50 mg after installation in a field.

In embodiments, a composition of the present disclosure releases the active ingredient for at least about one month after installation in a field. In embodiments, the composition releases the active ingredient for at least about 1 month, at least about 2 months, at least about 3 months, at least about 4 months, at least about 5 months, at least about 6 months, at least about 7 months, at least about 8 months, at least about 9 months, at least about 10 months, about least about 11 months, at least about 1 year, or more after installation in a field.

In embodiments, a composition of the present disclosure provides zero order release of the active ingredient for at least about month after installation in a field. In embodiments, the dispenser provides zero order release of the active ingredient composition for at least about 1 month, at least about 2 months, at least about 3 months, at least about 4 months, at least about 5 months, at least about 6 months, at least about 7 months, at least about 8 months, at least about 9 months, at least about 10 months, about least about 11 months, at least about 1 year, or more after installation in a field.

In embodiments, a composition of the present disclosure degrades from about 6 months to about 4 years after installation in a field. In embodiments, the composition degrades in about 6 months to about 1 year, about 6 months to about 2 years, about 6 months to about 3 years, about 6 months to about 4 years, about 1 year to about 2 years, about 1 year to about 3 years, about 1 year to about 4 years, about 2 years to about 3 years, about 2 years to about 4 years, or about 3 years to about 4 years after installation in a field. In embodiments, the composition degrades in about 6 months, about 1 year, about 2 years, about 3 years, or about 4 years after installation in a field. In embodiments, about 70% to about 100% of the composition degrades after installation in a field after about 6 months to 4 years. In embodiments, about 70% to about 80%, about 70% to about 90%, about 70% to about 100%, about 80% to about 90%, about 80% to about 100%, or about 90% to about 100% of the composition degrades after installation in a field after about 6 months to 4 years.

In embodiments, a composition of the present disclosure disrupts pest mating for at least about 30 days after installation to a field. In embodiment, the composition disrupts mating for at least about 50 days, at least about 55 days, at least about 60 days, at least about 65 days, at least about 70 days, at least about 75 days, at least about 80 days, at least about 85 days, at least about 90, at least about 95 days, or at least about 100 days after installation in a field.

In embodiments, a granule of the present disclosure disrupts pest mating for about 50 days after installation in a field. In embodiments, a dispenser of the present disclosure disrupts pest mating for about 90 days after installation in a field.

In embodiments, a composition of the present disclosure is contained in a sachet. In embodiments, a composition of the present disclosure comprises flakes contained in a sachet. In embodiment, a composition of the present disclosure comprises granules contained in a sachet.

In embodiments, a composition of the present disclosure comprises flakes, granules, and mixtures thereof. In embodiments, the flakes, granules, and mixtures thereof are joined together by a glue. In embodiments, the composition comprises flakes joined together by glue. In embodiments, the composition comprises granules joined together by glue.

In embodiments, of the present disclosure a dispenser comprising a semiochemical composition comprising Z9-14Ac and Z11-16Ac. In embodiments, the dispenser comprises about 1.5 to about 3 g of the semiochemical composition. In embodiments, the dispenser comprises about 1.5 g, about 2 g, about 2.5 g, or about 3 g of the semiochemical composition.

In embodiments, a composition of the present disclosure comprises: (a) a matrix comprising PCL; (b) a semiochemical composition comprising Z9-14Ac and Z:11-61Ac contained within the matrix; and (c) a filler comprising calcined kaolin contained within the matrix. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac:Z:11-61Ac is about 87:13. In embodiments, the composition further comprises an anticaking agent.

In embodiments, a composition of the present disclosure comprises: (a) a matrix comprising PCL; (b) a semiochemical composition comprising Z9-14Ac and Z:11-61Ac contained within the matrix, and (c) a filler comprising microcrystalline cellulose contained within the matrix. In embodiments, a weight ratio of the PCL to semiochemical composition to filler is 1:1:1. In embodiments, the composition comprises a dispenser. In embodiments, the dispenser is a cylindrical disc comprising a thickness of about 1.5 mm, a length of about 55 mm, and a height of about 90 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac to Z:11-61Ac is about 87:13. In embodiments, the composition further comprises an anticaking agent.

### Methods of Manufacturing Agrochemical Compositions

In one aspect, the present disclosure provides methods of manufacturing a controlled-release composition disclosed herein.

In embodiments, the methods comprise:
(a) homogenizing a filler, a binder, and an active ingredient composition; and
(b) extruding the homogenized mixture.

In embodiments, step (b) is conducted by twin-screw extrusion.

In embodiments, the active ingredient composition comprises one or more active ingredients. In embodiments, the active ingredient composition is a semiochemical composition comprises one or more semiochemicals.

In embodiments, the methods comprise forming a controlled-release granule, flake, dispenser, and mixtures thereof. In embodiments, the methods comprise homogenization of components at either ambient or elevated temperatures followed by the shaping into the final form (e.g., granule, flake, or dispenser).

In embodiments, the methods further comprise homogenizing an additive, antioxidant, UV-blocking agent, and/or anticaking agent with the filler, binder, and active ingredient composition.

In embodiments, extruding step (b) comprises extruding the homogenized mixture through a sheet dyeing machine to produce the controlled-release composition.

In embodiments, the methods further comprise: (c) cooling the controlled-release composition. In embodiments, the methods comprise cooling the controlled-release composition using a water bath and/or an air-cooling conveyor belt.

In embodiments, the methods further comprise: (d) cutting the controlled-release composition to target dimensions (e.g., to form a granule, flake, and/or dispenser).

In embodiments, the methods comprise extruding a string (e.g., cylindrical structure) of the composition and cutting the string to form granules.

In embodiments, the methods comprise extruding a strip (e.g., flattened structure) of the composition and cutting the strip to form dispensers and/or flakes.

### Methods of Use

In one aspect, the present disclosure provides methods of controlling pest populations in a field comprising one or more pests. In embodiments, controlling pest populations in a field reduces and/or prevents plant damage in the field.

In embodiments, the methods of controlling pest populations comprise attracting or repelling pests from a particular field (e.g., target area such as a vulnerable crop). In embodiments, the methods of controlling pest populations comprise pest trapping, pest monitoring, pest killing, and/or pest mating disruption.

In embodiments, methods of the present disclosure relate to controlling pest populations in a field, the methods comprising applying an effective amount of an agrochemical composition described herein to the field.

In embodiments, methods of the present disclosure relate to preventing and/or reducing plant damage in a field comprising one or more pests, the methods comprising applying an effective amount of an agrochemical composition described herein to the field.

In embodiments, the field comprises plants grown in a variety of situations to include plants grown in field crops, large scale row crop fields, rangelands, forests, golf courses, and nurseries. In embodiments, the field comprises vegetable crops, fruit trees, nut trees, and mixtures thereof.

In embodiments, field crops include alfalfa, barley, Bermuda grass, buckwheat, cotton, clover, corn, oat, millet, peanut, rice paddy, ryegrass, sorghum, sugarbeet, sudangrass, soybean, sugarcane, timothy, tobacco, wheat, and mixtures thereof. In embodiments, the field crops include apple, grape, orange, papaya, peach, strawberry, and mixtures thereof. In embodiments, the field crops include weeds known to serve as common hosts to pests such as bentgrass, Agrostis sp.; crabgrass, Digitaria spp.; Johnson grass, Sorghum halepense; morning glory, Ipomoea spp.; nutsedge, Cyperus spp.; pigweed, Amaranthus spp.; sandspur, Cenchriis tribuloides, and mixtures thereof.

In embodiments, the field is a corn field, and the pest comprises fall armyworm (FAW). In embodiments, the field is a rice paddy field, and the pest comprises yellow rice stemborer.

In embodiments, the methods of controlling pest populations comprise trapping one or more pests in a field, the methods comprising applying an effective amount of an agrochemical composition described herein to the field. In embodiments, the methods comprise adding the agrochemical composition to a trap prior to application to the field. Such traps are well known to one skilled in the art and are commonly used in many states and countries in pest eradication programs. In embodiments, the trap includes one or more septa, containers, or storage receptacles for holding the composition. Thus, in embodiments, the present disclosure provides a trap loaded with at least one agrochemical composition of the present disclosure.

In embodiments, the methods of controlling pest populations comprise disrupting pest mating by modulating the behavior of the pests. Mating disruption is a pest management technique designed to control pests by introducing artificial stimuli (e.g., a composition comprising a sex pheromone as disclosed herein) that confuses the pests and disrupts mating localization and/or courtship, thereby preventing mating and blocking the reproductive cycle.

In embodiments, the methods of the present disclosure comprise controlling pest populations in a field, the methods comprising applying an effective amount of an agrochemical composition comprising one or more pheromones described herein to the field. In many pest species (e.g., insects), females emit an airborne trail (“pheromone plume”) of a specific chemical blend constituting that species' sex pheromone. Males of that species use the information contained in the pheromone plume to locate the emitting female. Mating disruption exploits the males' natural response to follow the plume by introducing a pheromone into the males' habitat, which is designed to mimic the sex pheromone produced by the female. Thus, in embodiments, the methods of the present disclosure comprise applying an agrochemical composition comprising one or more pheromones described herein to the field, in which the one or more pheromones is not produced by a female pest.

In embodiments, the methods of the present disclosure further comprise monitoring a population of one or more pests in a field. In embodiments, the methods of monitoring the pest populations comprise counting the number of pests trapped in the field daily, weekly, bi-weekly, monthly, one every three months, or once a year. In embodiments, monitoring the pest population can aid in determining a particular type and/or dose of a composition to apply to the field. For example, a discovery of a high insect population can necessitate the use of methods for removal of the insect. Early warning of an infestation in a new habitat can allow action to be taken before the population becomes unmanageable. Conversely, a discovery of a low pest population can lead to a decision that it is sufficient to continue monitoring the population. Pest populations can be monitored regularly so that the pests are only controlled when they reach a certain threshold.

In embodiments, the methods further comprise controlling pest populations in a field by killing one or more pests in the field. In embodiments, the methods comprise incorporating a toxic substance into a trap comprising an agrochemical composition described herein to kill the pests after trapping. In embodiments, the methods comprising incorporating a fungus or virus into the trap comprising an agrochemical composition described herein to kill the pests after trapping. In embodiments, the methods including killing one or more pests via drowning and/or electrocution.

In embodiments, the methods comprise suppressing pest mating after applying an agrochemical composition of the present disclosure to the field. In embodiments, the methods comprise suppressing pest mating by at least about 30%, at least about 40%, at least about 50%, at least about 60%, at least about 70%, at least about 80%, at least about 90%, or at least about 100% after applying the agrochemical composition to the field. In embodiments, the methods include suppressing mating relative to an untreated field.

In embodiments, the methods of the present disclosure comprise reducing a pest population by at least about 50% after applying an agrochemical composition of the present disclosure to the field. In embodiments, the methods comprise reducing the pest population by at least about 50%, at least about 60%, at least about 70%, at least about 80%, at least about 90%, or at least about 100% after applying the agrochemical composition to the field. In embodiments, the methods include reducing a pest population relative to an untreated field.

In embodiments, the methods of the present disclosure comprise controlling pest population for at least about 60 days after applying an agrochemical composition of the present disclosure to a field. In embodiments, the methods comprising controlling pest population for at least about 60 days, at least about 70 days, at least about 80 days, at least about 90 days, at least about 100 days, at least about 120 days, at least about 130 days, at least about 140 days, at least about 150 days, at least about 160 days, at least about 170 days, at least about 180 days, at least about 190 days, or at least about 200 days after the agrochemical composition to the field.

In embodiments, the methods of the present disclosure comprise controlling a pest population, the methods comprising applying an agrochemical composition comprising one or more pheromones, in which the composition emits one or more pheromones for a period of time equivalent to at least one breeding season. In embodiments, the agrochemical composition emits one or more pheromones for at least about 1 week, 2 weeks, 3 weeks, 4 weeks, 5 weeks, 6 weeks, or more after application to a field.

In embodiments, the methods comprise applying the composition to a field at a rate from about 10 grams of active ingredient per hectare (g a.i./ha) to about 150 g a.i/ha. In embodiments, the methods comprise applying the composition to a field at a rate from about 10 g a.i./ha to about 70 g a.i./ha, about 30 g a.i./ha or about 60 g a.i./ha, about 50 g a.i./ha to about 70 g a.i./ha, about 50 g a.i./ha to about 90 g a.i./ha, about 50 g a.i./ha to about 110 g a.i./ha, about 50 g a.i./ha to about 130 g a.i./ha, about 50 g a.i./ha to about 150 g a.i./ha, about 60 g a.i./ha to about 80 g a.i./ha, about 60 g a.i./ha to about 100 g a.i./ha, about 60 g a.i./ha to about 120 g a.i./ha, about 60 g a.i./ha to about 140 g a.i./ha, about 70 g a.i./ha to about 90 g a.i./ha, about 70 g a.i./ha to about 110 g a.i./ha, about 70 g a.i./ha to about 130 g a.i./ha, about 70 g a.i./ha to about 150 g a.i./ha, about 80 g a.i./ha to about 100 g a.i./ha, about 80 g a.i./ha to about 120 g a.i./ha, about 80 g a.i./ha to about 140 g a.i./ha, about 90 g a.i./ha to about 110 g a.i./ha, about 90 g a.i./ha to about 130 g a.i./ha, about 90 g a.i./ha to about 150 g a.i./ha, about 100 g a.i./ha to about 120 g a.i./ha, about 100 g a.i./ha to about 140 g a.i./ha, about 110 g a.i./ha to about 140 g a.i./ha, about 120 g a.i./ha to about 150 g a.i./ha, or about 130 g a.i./ha to about 150 g a.i./ha. In embodiments, the methods comprise applying the composition to a field at a rate of about 10 g a.i./ha, 20 g a.i./ha, about 30 g a.i./ha, about 40 g a.i./ha, about 50 g a.i./ha, about 60 g a.i./ha, about 70 g a.i./ha, about 80 g a.i./ha, about 90 g a.i./ha, about 100 g a.i./ha, about 110 g a.i./ha, about 120 g a.i./ha, about 130 g a.i./ha, about 140 g a.i./ha, or about 150 g a.i./ha.

As will be apparent to one of skill in the art, the amount of an active ingredient or active ingredient composition used for a particular application can vary depending on several factors such as the type and level of infestation; the type of composition used; the concentration of the active ingredients; how the composition is provided, for example, the type of composition used (e.g., granules, flakes, and dispensers); the type of location to be treated; the length of time the method is to be used for; and environmental factors such as temperature, wind speed and direction, rainfall and humidity. Those of skill in the art will be able to determine an effective amount of active agent or active agent composition for use in a given application.

In embodiments, the present disclosure provides methods of controlling pest population in a field, the methods comprising applying an effective amount of a composition comprising (a) a matrix comprising PCL; (b) a semiochemical composition comprising Z9-14Ac and Z:11-61Ac contained within the matrix; and (c) a filler comprising calcined kaolin contained within the matrix to the field. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac:Z:11-61Ac is about 87:13. In embodiments, the composition further comprises an anticaking agent.

In embodiments, the present disclosure provides methods of controlling pest population in a field, the methods comprising applying an effective amount of a composition comprising (a) a matrix comprising PCL; (b) a semiochemical composition comprising Z9-14Ac and Z:11-61Ac contained within the matrix, and (c) a filler comprising microcrystalline cellulose contained within the matrix to the field. In embodiments, a weight ratio of the PCL to semiochemical composition to filler is 1:1:1. In embodiments, the composition comprises a dispenser. In embodiments, the dispenser is a cylindrical disc comprising a thickness of about 1.5 mm, a length of about 55 mm, and a height of about 90 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac to Z:11-61Ac is about 87:13. In embodiments, the composition further comprises an anticaking agent.

In embodiments, the present disclosure provides methods of controlling FAW in corn, the methods comprising applying an affective amount of an agrochemical composition described herein to a cornfield. In embodiments, the method controls FAW for about 60 days following application of a composition of the present disclosure to the cornfield.

In embodiments, the present disclosure provides methods of controlling FAW in corn, the methods comprising applying an effective amount of a composition comprising (a) a matrix comprising PCL; (b) a semiochemical composition comprising Z9-14Ac and Z:11-61Ac contained within the matrix; and (c) a filler comprising calcined kaolin contained within the matrix to a cornfield. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac:Z:11-61Ac is about 87:13. In embodiments, the composition further comprises an anticaking agent.

In embodiments, the present disclosure provides methods of controlling FAW in corn, the methods comprising applying an effective amount of a composition comprising (a) a matrix comprising PCL; (b) a semiochemical composition comprising Z9-14Ac and Z:11-61Ac contained within the matrix, and (c) a filler comprising microcrystalline cellulose contained within the matrix to a cornfield. In embodiments, a weight ratio of the PCL to semiochemical composition to filler is 1:1:1. In embodiments, the composition comprises a dispenser. In embodiments, the dispenser is a cylindrical disc comprising a thickness of about 1.5 mm, a length of about 55 mm, and a height of about 90 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac to Z:11-61Ac is about 87:13. In embodiments, the composition further comprises an anticaking agent.

In embodiments, the present disclosure provides methods of controlling yellow rice stemborer in rice, the methods comprise applying an affective amount of an agrochemical composition described herein to a rice paddy field. In embodiments, the methods control yellow rice stemborer for about 60 days following application to the rice paddy field.

In embodiments, the present disclosure provides methods of controlling yellow rice stemborer in rice, the methods comprising applying an effective amount of a composition comprising (a) a matrix comprising PCL; (b) a semiochemical composition comprising Z9-14Ac and Z:11-61Ac contained within the matrix; and (c) a filler comprising calcined kaolin contained within the matrix to a rice paddy field. In embodiments, a weight ratio of the PCL to semiochemical composition to filler is 1:1:1. In embodiments, the composition comprises a granule. In embodiments, the granule is a cylinder comprising a height of about 3 mm and a circumference of about 3 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac:Z:11-61Ac is about 87:13. In embodiments, the composition further comprises an anticaking agent.

In embodiments, the present disclosure provides methods of controlling yellow rice stemborer in rice, the methods comprising applying an effective amount of a composition comprising (a) a matrix comprising PCL; (b) a semiochemical composition comprising Z9-14Ac and Z:11-61Ac contained within the matrix, and (c) a filler comprising microcrystalline cellulose contained within the matrix to a rice paddy field. In embodiments, a weight ratio of the PCL to semiochemical composition to filler is 1:1:1. In embodiments, the composition comprises a dispenser. In embodiments, the dispenser is a cylindrical disc comprising a thickness of about 1.5 mm, a length of about 55 mm, and a height of about 90 mm. In embodiments, the semiochemical composition further comprises an antioxidant. In embodiments, the antioxidant is TBHQ, BHT, and mixtures thereof. In embodiments, the semiochemical composition comprises about 0.5 wt % TBHQ, 0.5 wt % BHT, and mixtures thereof. In embodiments, a weight ratio of the Z9-14Ac to Z:11-61Ac is about 87:13. In embodiments, the composition further comprises an anticaking agent.

### NUMBERED EMBODIMENTS OF THE DISCLOSURE

In addition to the disclosure above, the Examples below, and the appended claims, the disclosure sets forth the following numbered embodiments.

1. A controlled-release agrochemical composition comprising:
a matrix; and
a semiochemical composition contained within the matrix.

2. The composition of embodiment 1, wherein the matrix comprises a binder.

3. The composition of embodiment 2, the binder is a biodegradable polymer.

4. The composition of embodiment 3, wherein the biodegradable polymer is selected from the group consisting of polycaprolactone (PCL), poly(butylene adipate-co-terephthalate) (PBAT), polybutylene succinate (PBS), polyhydroxyalkanoate (PHA) and polylactic acid (PLA).

5. The composition of any one of embodiments 3-4, wherein the composition comprises about 10 wt % to about 98 wt % of the biodegradable polymer

6. The composition of embodiment 2, wherein the binder is a non-biodegradable polymer.

7. The composition of embodiment 6, wherein the non-biodegradable polymer is selected from the group consisting of low density polyethylene (LDPE), ethylene-vinyl acetate (EVA), high density polyethylene (HDPE), and polyvinyl acetate (PVA).

8. The composition of any one of embodiments 2-7, wherein the semiochemical composition is miscible in the binder.

9. The composition of any one of embodiments 2-7, wherein the semiochemical composition is immiscible in the binder.

10. The composition of any one of embodiments 2-7, wherein the semiochemical composition comprises droplets in the matrix composition.

11. The composition of any one of embodiments 1-10, further comprising a filler contained within the matrix.

12. The composition of embodiment 11, wherein the filler is selected from the group consisting of a clay (including organoclay), a zeolite, talcum, shredded hay, cotton, cork, hemp, wood chips, wood dust, wood excelsior, microcrystalline cellulose, paper pulp, kaolin, calcined kaolin, chitosan, and mixtures thereof.

13. The composition of embodiment 11, wherein the filler is a biomass from a fermentation.

14. The composition of any one of embodiments 11-12, wherein the filler is an active filler (i.e., a filler that retains the semiochemical).

15. The composition of any one of embodiments 11-14, wherein the composition comprises about 1 wt % to about 80 wt % of filler.

16. The composition of any one of embodiments 1-15, wherein the composition comprises polycaprolactone and microcrystalline cellulose.

17. The composition of any one of embodiments 1-15, wherein the composition comprises polycaprolactone and calcined kaolin.

18. The composition of any one of embodiments 1-15, wherein the composition comprises PLA and microcrystalline cellulose.

19. The composition of any one of embodiments 1-15, wherein the composition comprises EVA and microcrystalline cellulose.

20. The composition of any one of embodiments 1-15, wherein the composition comprises EVA and calcined kaolin.

21. The composition of any one of embodiments 1-15, wherein the composition comprises PBS and microcrystalline cellulose.

22. The composition of any one of embodiments 1-15, wherein the composition comprises PHA and microcrystalline cellulose.

23. The composition of any one of embodiments 1-15, wherein the composition comprises PBS and calcined kaolin.

24. The composition of any one of embodiments 2-23, wherein the weight ratio of semiochemical composition to binder is 99:1 to 60:40.

25. The composition of any one of embodiments 2-23, wherein the weight ratio of semiochemical composition to binder is 20:80 to 80:20.

26. The composition of any one of embodiments 2-25, wherein the weight ratio of semiochemical composition to binder is about 1:1.

27. The composition of any one of embodiments 11-26, wherein the weight ratio of filler to semiochemical composition is 99:1 to 60:40

28. The composition of any one of embodiments 11-26, wherein the weight ratio of filler to semiochemical composition is about 1:1

29. The composition of any one of embodiments 1-28, wherein the composition further comprises an antioxidant.

30. The composition of any one of embodiments 1-29, wherein the composition comprises about 0.01 wt % to about 5 wt % of an antioxidant.

31. The composition of any one of embodiments 1-30, wherein the composition further comprises a UV-blocking agent.

32. The composition of embodiment 31, wherein the UV-blocking agent is selected from the group consisting of methyl cinnamate, iron oxides, carbon black, and octabenzone.

33. The composition of any one of embodiments 1-32, wherein the composition further comprises an anticaking agent.

34. The composition of embodiment 31, wherein the anticaking agent is selected from the group consisting of charcoal, amorphous silica, and fumed silica.

35. The composition of any one of embodiments 1-34, wherein the composition comprises about 0 wt % to about 2 wt % of an anticaking agent.

36. The composition of any one of embodiments 1-35, further comprising an additive contained within the matrix, wherein the additive is selected from the group consisting of a dye, reflectant, inorganic salt and organic salt.

37. The composition of any one of embodiments 1-36, wherein the semiochemical composition is selected from the group consisting of an allomone, a kairomone, a pheromone, and mixtures thereof.

38. The composition of any one of embodiments 1-36, wherein the semiochemical composition comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof.

39. The composition of any one of embodiments 1-36, wherein the semiochemical composition comprises (Z)-9-Hexadecenal (Z9-16Ald), (Z)-11-Hexadecenal (Z11-16Ald), (Z)-13-Octadecenal (Z13-18Ald), and (Z)-9-Octadecenal (Z9-18Ald).

40. The composition of embodiment 39, wherein the semiochemical composition comprises about 75 wt % of (Z)-9-Hexadecenal (Z9-16Ald), about 10 wt % (Z)-11-Hexadecenal (Z11-16Ald), about 8 wt % of (Z)-13-Octadecenal (Z13-18Ald), and about 7 wt % of (Z)-9-Octadecenal (Z9-18Ald).

41. The composition of any one of embodiments 1-36, wherein the semiochemical composition comprises (Z)-9-Tetradecenyl Acetate (Z9-14Ac) and (Z)-11-Hexadecenyl Acetate (Z11-16Ac).

42. The composition of embodiment 41, wherein the semiochemical composition comprises about 87 wt % of (Z)-9-Tetradecenyl Acetate (Z9-14Ac) and about 13 wt % of (Z)-11-Hexadecenyl Acetate (Z11-16Ac).

43. The composition of any one of embodiments 1-42, wherein the composition comprises about 1% to about 50% by weight of the semiochemical composition.

44. The composition of any one of embodiments 1-47, wherein the composition comprises about 1 mg to about 5 g of the semiochemical composition.

45. The composition of any one of embodiments 1-44, wherein the composition releases about 25 mg of the semiochemical per day after installation in a field.

46. The composition of any one of embodiments 1-45, wherein the composition releases the semiochemical for at least about month after installation in a field.

47. The composition of any one of embodiments 1-46, wherein the composition provides zero order release of the semiochemical for at least about month after installation in a field.

48. The composition of any one of embodiments 1-47, wherein the composition is a dispenser.

49. The dispenser of embodiment 48, wherein the dispenser is in the shape of a cylindrical disc or rectangular prism.

50. The dispenser of any one of embodiments 48-49, wherein the surface area of the dispenser is from about 50 cm² to about 150 cm²

51. The dispenser of any one of embodiments 48-49, wherein the surface area of the dispenser is from about 1 cm² to about 100 cm².

52. The dispenser of any one of embodiments 48-51, wherein the thickness of the dispenser is from about 0.1 mm to about 10 mm.

53. The dispenser of any one of embodiments 48-51, wherein the thickness of the dispenser is from about 1 mm to about 3 mm.

54. The dispenser of any one of embodiments 48-51, wherein the thickness of the dispenser is from about 1 mm to about 2 mm.

55. The composition of any one of embodiments 1-47, wherein the composition is a granule.

56. The granule of embodiment 55, wherein the shape of the granule is a cylinder, cube, sphere, irregular 3d object, or a mixture thereof.

57. The granule of any one of embodiments 55-56, wherein the mean dimension of the granule is from about 0.1 mm to about 10 mm.

58. The granule of any one of embodiments 55-57, wherein the mean volume of the granule is from about 0.001 mm³ to about 1000 mm³.

59. The composition of any one of embodiments 1-47, wherein the composition is a flake.

60. A controlled-release agrochemical dispenser comprising the flakes of embodiment 59 or the granules of any one of embodiments 55-58 contained in a sachet.

61. A controlled-release agrochemical dispenser comprising the flakes embodiment 59 or the granules of any one of embodiments 55-58 joined together by a glue.

62. A method of controlling fall armyworm (FAW) in corn, the method comprising applying an effective amount of the controlled-release agrochemical composition of any one of claims 1-47, the dispenser of any one of embodiments 48-54, the flake of embodiment 59 or the granule of any one of embodiments 55-58 to a corn field.

63. The method of embodiment 62, wherein the application rate is from about 50 g a.i./ha to about 150 g a.i./ha.

64. The method of any one of embodiments 62-63, wherein the method controls FAW for about 60 days following application.

65. A method of controlling yellow rice stemborer in rice, the method comprising applying an effective amount of the controlled-release agrochemical composition, dispenser, flake, or granule of any of the previous numbered embodiments to a rice paddy field.

66. The method of embodiment 66, wherein the method controls yellow rice stemborer for about 60 days following application.

67. A process for making a controlled-release agrochemical dispenser, flake or granule, the method comprising:
(a) homogenizing a filler, binder and a semiochemical composition and
(b) extruding the homogenized mixture.

68. The process of embodiment 67, wherein the step (b) is conducted by twin-screw extrusion.

### EXAMPLES

The present invention is further illustrated by reference to the following Examples. However, it is noted that that Examples, like the embodiments described above, are illustrative and are not to be construed as restricting the scope of the invention in any way.

### Example 1—Methods of Making Agrochemical Compositions and Associated Characterizations

The following example provides an exemplary method for preparing agrochemical compositions of the present disclosure using the binder PCL, as well as the properties of the compositions.

Two Component System (Binder and Active Ingredient): Solid and room temperature stable formulations were obtained by homogenizing PCL and mixture of (Z)-9-Tetradecenyl Acetate (Z9-14Ac) and (Z)-11-Hexadecenyl Acetate (Z11-16Ac) in a mass ratio of 87:13 (“FAW blend”) below 200° C. with stirring. Table 3 enumerates eight formulations prepared according to this procedure, where each formulation comprised 2.5 g of the FAW blend but have different mass ratios of the FAW blend: PCL.

TABLE 3
Two Component Formulations of Example 1

| Sample # | FAW:PCL Ratio |
|---|---|
| Sample 1 | 80:20 |
| Sample 2 | 80:20 |
| Sample 3 | 75:25 |
| Sample 4 | 75:25 |
| Sample 5 | 70:30 |
| Sample 6 | 70:30 |
| Sample 7 | 60:40 |
| Sample 8 | 60:40 |

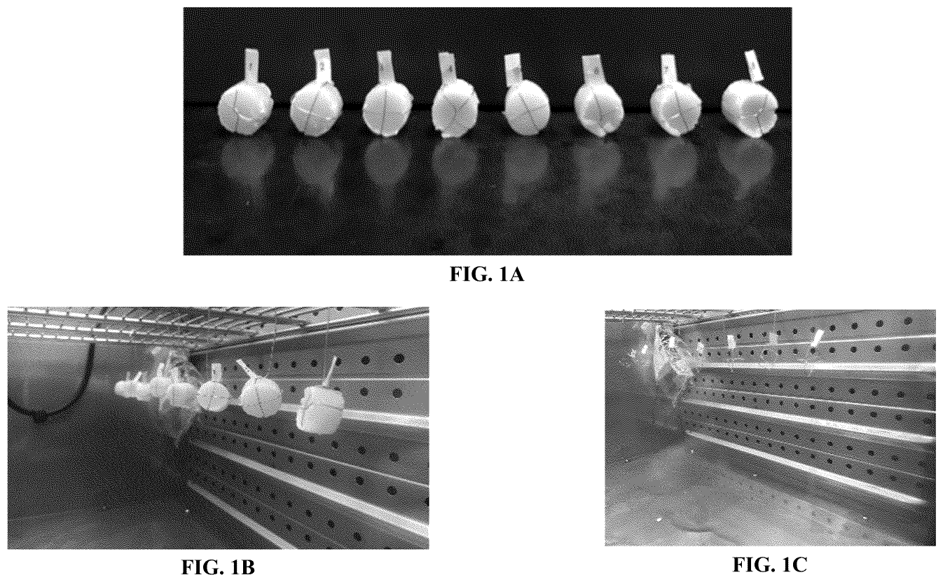

The highest FAW blend loading of this two components system resulting in a formulation that would not exhibit any visible oil (FAW blend) phase separation was determined to be 80 wt % (FIG. 1A, Samples 1 and 2). FIG. 1B demonstrates the stability of the formulations in an environmental chamber at 50° C., 50% RH at 0 h. Further reduction of the FAW blend was not possible using the same method due to the high viscosity of the resulting system with visible inhomogeneous regions that would not solubilize over time. The resulting high active ingredient loading, however, decreased the melting temperature of the overall formulation to below 50° C., making these systems highly sensitive to slightly elevated temperatures (FIG. 1C, showing samples 1-8 in an environmental chamber at 50° C., 50% RH at 1 h).

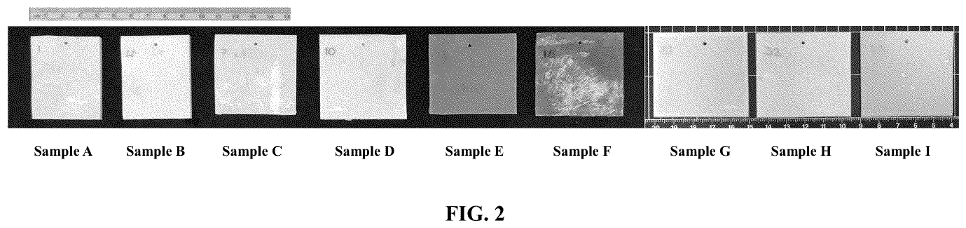

Three Component System (Binder, Active Ingredient, and Filler): In an effort to make the PCL-based formulation more robust and stable, the FAW blend loading was decreased and a third component, a filler, was introduced into the formulation. This three-component system was produced at 90° C. on a Brabender homogenizer and afforded up to 40 wt % loading of the FAW blend (See Example 3, Process 1). The tested fillers included kaolin (Sigma brand), kaolin (KaMin brand, 80B), calcined kaolin (KaMin brand, 70C), zeolite (KMI brand), zeolite (Heiltrophen brand, EU), talcum (FisherSci brand), microcrystalline cellulose (MCC 101), and Talcum, FisherSci as enumerated in Table 4. The maximum blend loading using Brabender to obtain a stable formulation was determined experimentally with the formulations depicted in FIG. 2. The post Brabender formulations were heat pressed into 2.5 mm thick sheets and cut, so that each piece contained 2.50 g of the FAW blend.

TABLE 4
Three Component Formulations of Example 1

| Sample # | Filler | Filler:PCL:FAW Blend |
|---|---|---|
| Sample A | Kaolin, Sigma Aldrich | 3:3:4 |
| Sample B | KaMin 70C (Calcined | 3:3:4 |
| | Kaolin) | |
| Sample C | KaMin80B (Kaolin) | 1:1:1 |
| Sample D | Microcrystalline Cellulose | 1:1:1 |
| Sample E | Zeolite from EU | 1:1:1 |
| Sample F | Zeolite from US, KMI | 4:2.5:2.5 |
| Sample G | Kaolin, Sigma Aldrich | 1:1:1 |
| Sample H | KaMin70C (Calcined Kaolin) | 1:1:1 |
| Sample I | Talcum, FisherSci | 1:1:1 |

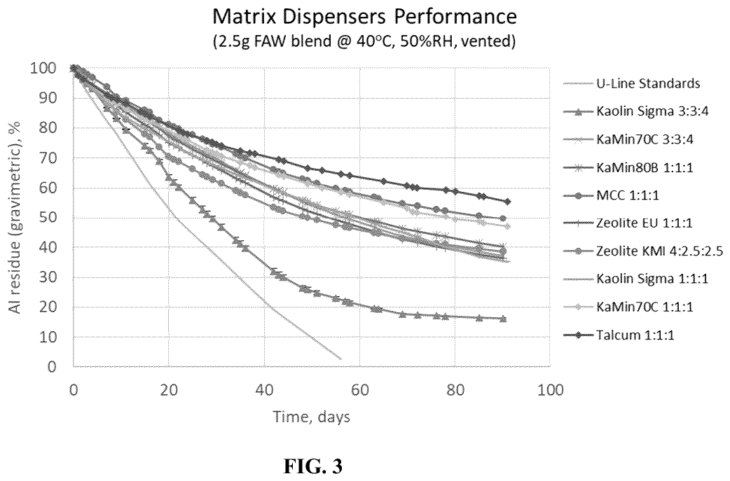

The performance of these matrix dispensers was evaluated in triplicates in an environmental chamber at 40° C., 50% RH for at least 90 days (FIG. 3). The triplicates of the same formulation exhibited high consistency in the performance and each formulation released FAW blend in a predictable manner, following some form of a pseudo first order kinetics. The repartition of this performance studies resulted in selection of two formulations that were not only consistent among triplicates in the same batch, but across two batches as well Formulations D and H.

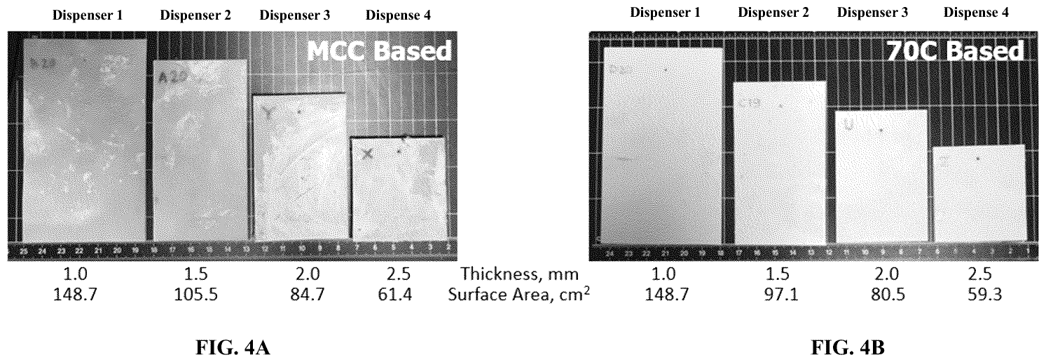

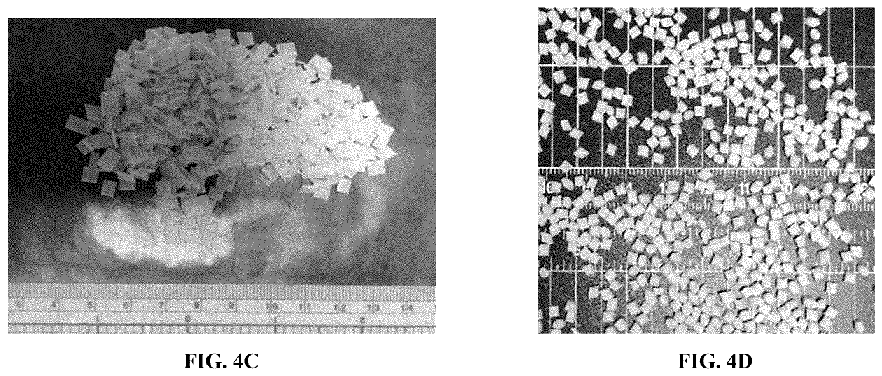

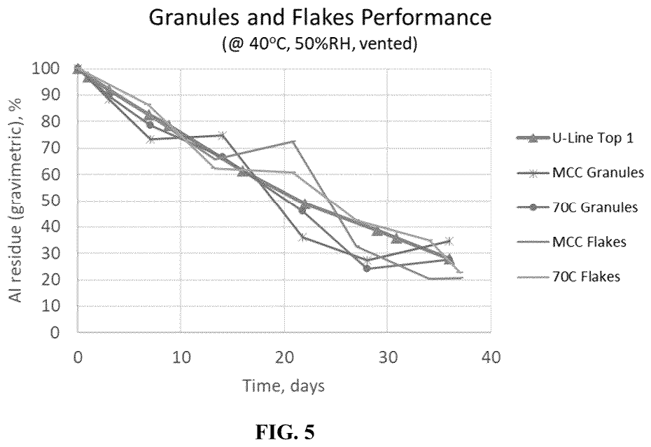

The difference between two selected formulations (D and H) was only the filler, as both comprised of all three components in the weight ratio of 1:1:1. In particular, Formulation D comprised the filler microcrystalline cellulose (MCC 101) and the Formulation H comprised the filler KaMin 70C. Formulations D and H were further shaped into dispensers (FIGS. 4A-4B), flakes (FIG. 4C), and granules (FIG. 4D) according to the processes described in Example 3.

Dispensers: FIGS. 4A-4B show four different sized dispensers formed from Formulations D and H, respectively having different thickness and surface areas as enumerated in Table 5.

TABLE 5
Dimensions of the Three Component Dispensers formed
from Formulations D and H

| | | | Surface Area |
|---|---|---|---|
| Formulation | Dispenser # 1 | Thickness (cm) | (cm²) |
| Formulation D | 1 | 1 | 148.7 |
| | 2 | 1.5 | 105.5 |
| | 3 | 2 | 84.7 |
| | 4 | 2.5 | 61.4 |
| Formulation H | 1 | 1 | 148.7 |
| | 2 | 1.5 | 97.1 |
| | 3 | 2 | 80.5 |
| | 4 | 2.5 | 59.3 |

By keeping the weight and the composition of a dispenser the same for both formulations, while changing the thickness, and the surface as a consequence, the FAW release properties can be modulated. This indicates that characteristics such as surface area can influence the properties of the system defining the release behavior. Thus, the release properties of the dispensers of the present disclosure can be tuned.

Granules and Flakes: The PCL formulations based on Formulations D and H were also shaped into flakes (FIG. 4C, PCL-based flakes containing KaMin70C) and granules (FIG. 4D, PCL-based granules containing MCC101). In a particular set of experiments, both granules and flakes of Formulations D and H were evaluated in an environmental chamber to determine their FAW blend release properties. The gravimetric loss kinetics results are outlined in the FIG. 5. Each datapoint for any flakes or granules in FIG. 5 represents the separate sample that after each weight measurement was removed from the chamber and underwent the destructive analysis. This was done to compare the gravimetric weight loss with the analytically supported release profile of each system. The destructive analysis confirmed that observed gravimetric weight loss profile closely mimics the real FAW blend loss, but some difference was observed. This difference is explained by the water absorbed by each formulation, exhibiting larger gap for MCC based system, which is expected due to higher hygroscopicity of MCC when compared to calcined kaolin (KaMin70C).

### Example 2—Methods of Making Agrochemical Compositions and Associated Characterizations

The following example provides exemplary methods for preparing agrochemical compositions of the present disclosure using the binder PLA, as well as the properties of the compositions. PLA is a bioderived, commercially produced, biodegradable, and compostable material, widely utilized as an alternative to petroleum-based polymers. While it is readily sourceable, its high melting point of >170° C. makes PLA hard to use for to produce agrochemical formulations for a wide variety of pheromones. However, because the components of the FAW blend have boiling points (>300° C.) far above the boiling point of PLA, the FAW blend is a suitable material for pursuit of PLA-based formulations.

The FAW blend is not miscible with PLA and therefore, introduction of a filler material helps to “retain” the FAW blend and incorporate the blend into the PLA matrix. The experimentation with materials like zeolites, kaolines, and microcrystalline cellulose, after determining components' ratio, did produce the visually homogeneous formulation upon mixing at 175° C. Unfortunately, the product in each case was too brittle and easily turned into crumbles by hands, making it challenging to heat press into stable dispensers.

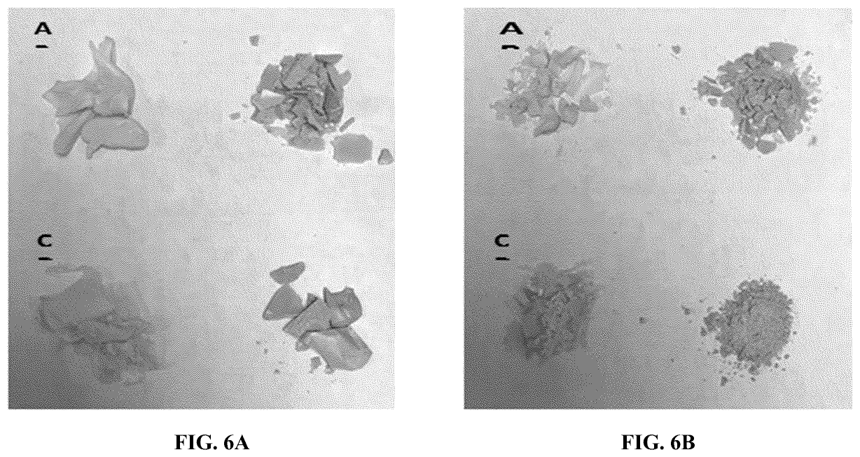

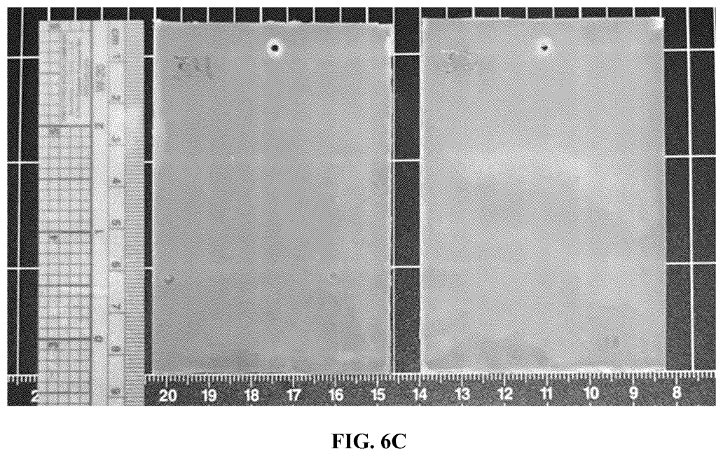

To reduce the crumbliness of the formulation, a larger particle (1-2 mm) of paper pulp, also often referred as the wood pulp, was introduced into the formulation (FIGS. 6A-6B and Table 6). Although Formulations A-D appeared to be prone to crumbling by hands at room temperature post mixing, all but one, Formulation D experienced some degree of hardening while stored in 8° C. refrigerator for 3 months (FIG. 6A). Nonetheless, all four formulations could still be turned into crumbles in a mortar after slight grinding (FIG. 6B).

TABLE 6
Formulations of Example 2

| Formulation | Binder | Filler | FAW Blend | Wood Pulp/Rosin |
|---|---|---|---|---|
| Formulation A | 33.33% PLA | 33.33% KaMin 70C | 33.33% | — |
| Formulation B | 50.00% PLA | 30.00% KaMin 70C | 20.00% | — |
| Formulation C | 33.33% PLA | 33.33% MCC | 33.33% | — |
| Formulation D | 41.67% PLA | 30.00% KaMin 70C | 20.00% | 8.33% |

Accordingly, the introduction of rosin into the formulation seems to further improve the ability of the matrix material to be converted into powder when compared to a similar formulation containing only PLA, FAW blend, and a filler.

Mixing of PLA, paper pulp, and FAW blend components in a weight ratio of 5:3:2 at 175° C. for 20 minutes resulted in a formulation that was pressed into dispensers (FIG. 6C, PLA-based FAW dispensers). The size of dispensers was 8.4×6.6×0.25 mm and each nominally contained about 2.5 g of FAW blend.

### Example 3—Methods of Preparing Dispensers, Granules and Flakes

The following Examples provides methods for preparing dispensers, granules, and flakes utilizing the formulations of Examples 1-2.

Process 1—a Mixing, Pressing, and Cutting Process for Preparing Dispensers and Flakes:

Mixing: The three heating blocks of the Brabender were set to 90° C. in case of PCL system and 175° C. in case of PLA. A proper amount of a polymer, filler, and FAW blend were premixed in the weighing dish. The overall mixture weight was always 60 g. After the mixture was homogenized at room temperature by hand mixing, the material was transferred to the mixing part of the Brabender and left mixing for 20 minutes at 90 RPM. The temperature on all three heating blocks was then set to 50° C. in case of PCL system and 150° C. in case of PLA. When the temperature approached 70° C. in case of PCL system and 150° C. in case of PLA the heating blocks were taken apart and material was collected.

Pressing: The pressing was performed on the pneumatic heat press at 90° C. in case of PCL system and 175° C. in case of PLA. The appropriate amount of material (depends on the density, in this particular set 38-42 g) was placed on the aluminum sheet previously covered with polyimide liner. The mold of a particular thickness was then placed around the material. The second layer of polyimide liner followed by an aluminum sheet was placed on top of the material and placed on top of the bottom heating block of the preheated press. The pressing was performed for 2 minutes. After this, the whole assembly of the material covered with top and bottom layers of the polyimide and aluminum sheets was placed on the benchtop and let to cool down to room temperature. The top alumina sheet was removed followed by the removal of the two polyimide sheets. The square “tile” of the pressed material was weighted out to ensure the integrity of the composition after pressing.

Cutting: The surface area was calculated to ensure that the resulting dispenser will have around 2.50 g of the FAW blend in case dispensers and determined by the size in case of flakes. The appropriate size of the dispenser and flakes was cut with the help of a paper trimmer or a razor in a few dispenser cases. In case of dispensers the hole was manually punched with a hole punch.

Process 2—an Extrusion and Cutting Process for Preparing Dispensers, Granules, and Flakes:

Extrusion: The two components (PCL and MCC 101 or KaMin70C) are premixed and fed into the extruder's feed throat through the feeding barrel. The temperature of the barrel 1 that follows the throat is 73° C. The FAW blend is injected in the system after this in the barrel 4 which is heated at 60° C. The temperature of the preceding barrels 2 and 3 is 78° C. The components mixture is homogenized by the two spinning in opposite directions (from edge to center) screws (ZSK30) that are located in the heat-controlled metal compartment with multiple heating barrels. The barrels 5-7 are heated at 60° C. and are followed by barrels 8 and 9 at 70° C. The screws movement pushes the formulation through the opening at the other end of the extruder. The rate of the extrusion for granules was 30 lb./min. In case of granules, the die cut at the end of the barrel 9 was a circle 2 mm in diameter. In case of flakes, the die cut was a rectangle 4 mm wide×1 mm tall. In case of dispenser extrusion development, a 4′ inch wide and adjustable by height lip die was used.

Cutting: The extruded material is then shortly submerged into a water bath to rapidly cool and then placed onto a Teflon (or stainless-steel belt) for further cooling. Multiple drying fans blow a room temperature air on the extruded material throughout the length of the belt to avoid any significant amount of water being absorbed by the extruded material. The resulting extruded material, string (for granules) or ribbon (for flakes or dispensers) is cut to a target size by pelletizer knives. The dispensers are cut either by the rolling knife or manually. Granules are put through sieves of the appropriate time (multiple times if needed) to reduce particle size distribution of the final formulation form.

Process 3—a Extrusion, Pressing, and Cutting Process for Preparing Dispensers, Granules, and Flakes:

Process 3 is analogous to the Process 1 except Process 3 skips the mixing step of Process 1 and instead, uses the compounded granules (output of the Process 3) as a material for the pressing step.

### Example 4—Controlled-Release Studies

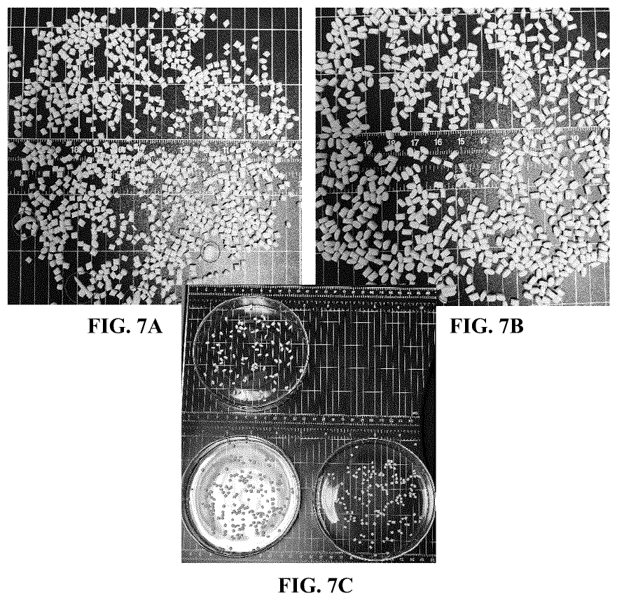

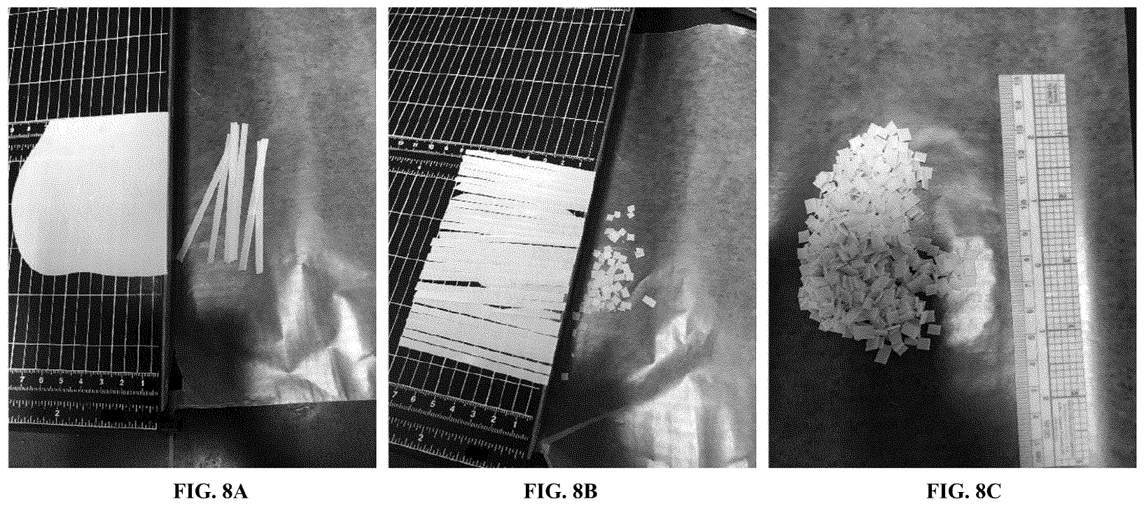

In this study, five formulations (Table 7) were produced having 33.3% filler (either 70C or MCC), 33.3% PCL, and 33% FAW blend. The density of MCC formulations was 1.12 g/cm³, and that of 70C formulations was 1.27 g/cm³. Formulations PRX-01GA1-21000, -21001, and 21002 were cylinders with 2 mm diameter and 2 mm height (FIGS. 7A-7C), while PRX-01GA1-21004 and 21005 were 4 mm×4 mm×1 mm flakes (FIGS. 8A-8C).

TABLE 7
Formulations of Example 5 and Corresponding Release Data

| | Size | Composition (Filler:polymer: | Lab Release | Soil Release |
|---|---|---|---|---|
| PRX-01GA1- | (mm) | FAW blend) | Test | Test |
| 21000 | 2 × 2 × 2 | MCC:PCL:FAW = 1:1:1 | >30 days | >30 days |
| 21001 | 2 × 2 × 2 | 70C:PCL:FAW = 1:1:1 | >30 days | >30 days |
| 21002 | 4 × 2 × 2 | 70C:PCL:FAW = 1:1:1 | >30 days | — |
| 21004 | 4 × 4 × 1 | MCC:PCL:FAW = 1:1:1 | >30 days | >30 days |
| 21005 | 4 × 4 × 1 | MCC:PCL:FAW = 1:1:1 | >30 days | >30 days |

Granule Production:

Granules PRX-01GA1-21000, -21001, and -21002, were produced using the twin-screw extruder at Aspen Research. Screw speed was set as 250 rpm. Power was 2.873 kW, and the throughput rate was 30 lb./hr. PCL and filler were fed in Barrel 1, and FAW blend was fed in Barrel 4. The temperature of Barrel 1 was set to 73° C., Barrel 2-3 to 78° C., Barrel 4-7 to 60° C., and Barrel 8-9 to 70° C. Strands were formed through two holes (φ=2 mm) at the end of extruder, immediately submerged in a water-cooling bath, and pulled on a conveyer belt. The cooled 2 mm strands were pelletized to granules. PRX-01GA1-21004 and PRX-01GA1-21005 were produced as following flakes production methods described below using granules −21000 and −21001 as a starting material, respectively.

Flake Production:

The pressing was performed on the pneumatic heat press at 90° C. The appropriate number of granules (depends on the density, in this particular set 38-42 g) was placed on the aluminum sheet previously covered with polyimide liner. The mold of a particular thickness was then placed around the material. The second layer of polyimide liner followed by an aluminum sheet was placed on top of the material and placed on top of the bottom heating block of the preheated press. The pressing was performed for 2 minutes. After this, the whole assembly of the material covered with top and bottom layers of the polyimide and aluminum sheets was placed on the benchtop and let to cool down to room temperature. The top alumina sheet was removed followed by the removal of the two polyimide sheets. The square “tile” of the pressed material was weighted out to ensure the integrity of the composition after pressing. The appropriate size of the flake was cut with the help of a paper trimmer.

Controlled-Release:

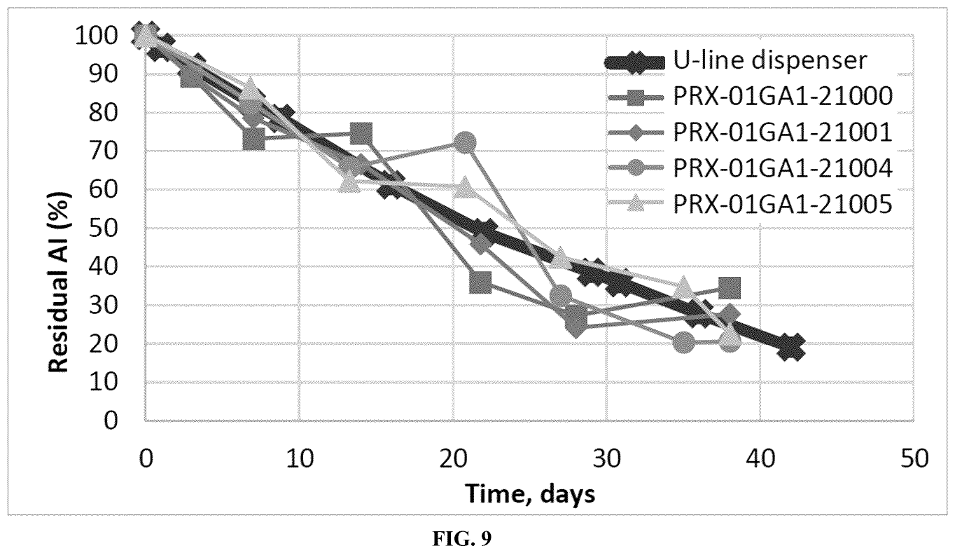

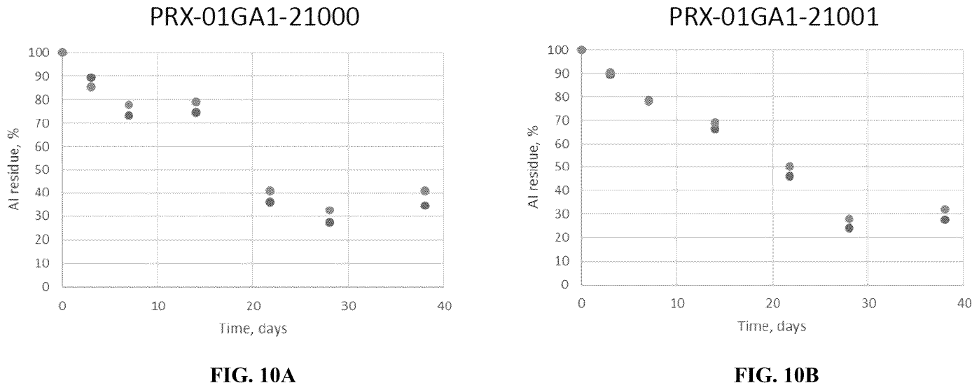

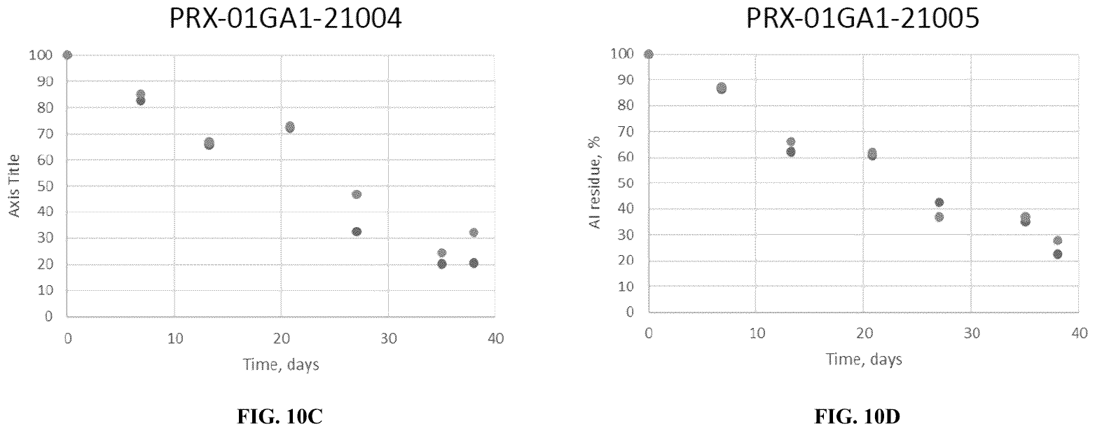

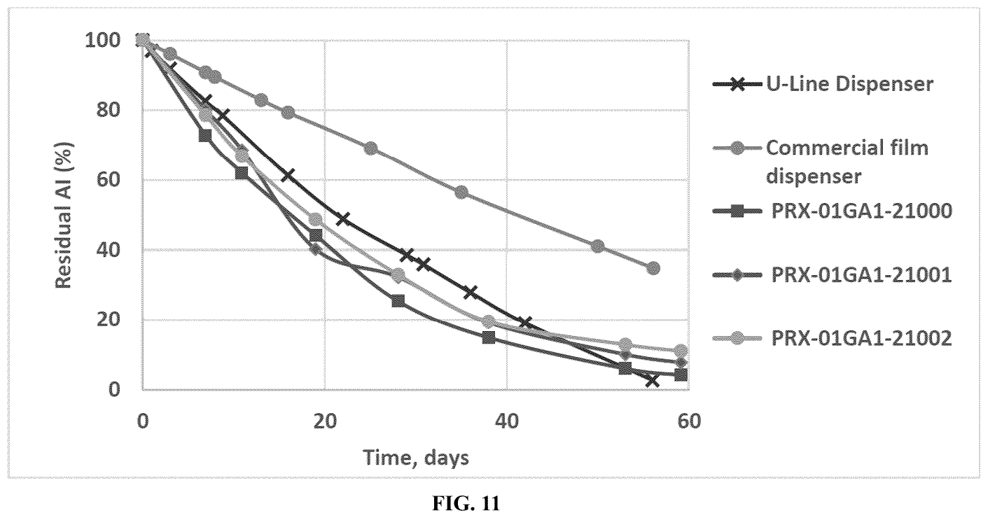

FIG. 9 shows the gravimetric weight loss (GWL) of formulations, PRX-01GA1-21000, -21001, -21004, and -21005 along with U-line film dispenser. Each data point in this figure except for the U-line film dispenser represents the separate sample that was removed after each weight measurement from the chamber and underwent the destructive GC analysis in order to compare the gravimetric weight loss with the analytically supported release profile of each formulation. Since each point is from different samples, the GWR data are not very smooth. The destructive analysis results in FIGS. 10A-10D confirmed that the observed gravimetric weight loss profiles are very close to the real FAW AI loss on obtained from GC. In general, there is no large difference between granules (−21000 and −21001) and flakes (−21004 and −21005), and these granules mimic the release of the U-line film dispenser. The GWL experiments were repeated with commercial film dispensers as shown in FIG. 11, which shows smother AI releasing profiles since there was no destructive analysis and data points were obtained from the same sample. The granular formulations release AI for about 50 days, which is shorter than the commercial dispensers that last for 90-100 days.

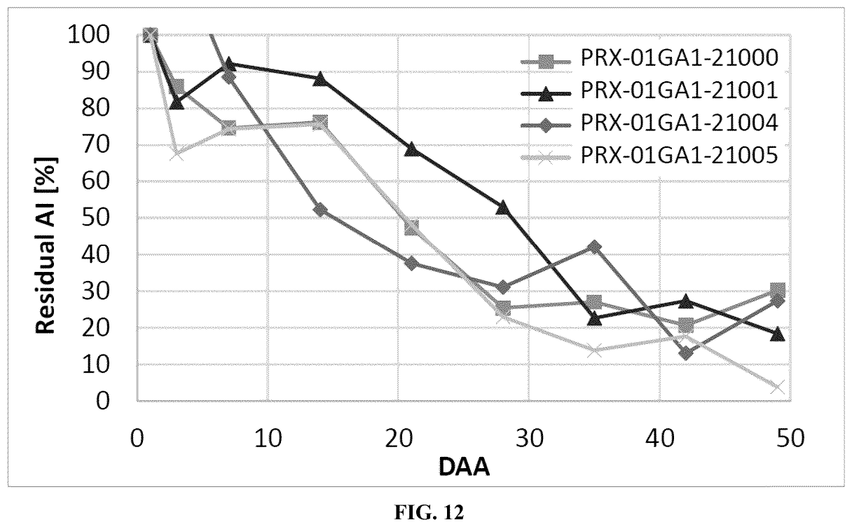

Soil assay that quantifies residual AI of the granular formulations on ground in a field, was tested in Jupiter, FL (weather conditions: minimum temperature of 16.3° C., maximum temperature of 25.2° C., precipitation of 1.3 mm, cloud coverage 44.3%, dew point 15.5° C., relative humidity 73.3%, and wind speed 17 km/hr). The soil assay in FIG. 12 shows very similar release profiles as the lab release tests, lasting for about 50 days. This similarity in release profiles suggests that the granular formulations can withstand adverse external environmental factors such as UV, hydroxy radical, ozone, etc. that are not easy to reproduce in lab release test conditions.

Conclusion:

PCL-based FAW granules with two different types of fillers were successfully produced using a twin-screw extruder. Lab environmental chamber release tests and soil assays showed a promising AI release duration of about 50 days. This similarity in the release profiles suggests that the granular formulations can withstand adverse external environmental factors such as UV, hydroxy radical, ozone, etc. that are not easy to reproduce in lab release test conditions.

### Example 5—FAW Moth Capture

Fall Armyworm (FAW), Spodoptera frugiperda (J.E. Smith) (Lepidoptera: Noctuidae) is the main pest in corn, causing severe damages in the corn whorl as well as direct injury to the ear, resulting in yield reductions ranging from 21% to 73%. The chemical control of this target insect with synthetic insecticides is the traditional primary control tactic used to manage this pest in corn. However, it is difficult for the sprayed active ingredients to reach the insects due to the movement of FAW larvae into the corn whorl, which impacts the efficacy of the insecticides. In addition, traditional chemical insecticides are not a sustainable practice for pest management. Considering the challenges associated with managing FAW populations in corn, the following study was conducted to identify formulations that can cause mating disruptions within a treated targeted area, and consequently, reduce the number of larvae and crop damage. In specific, the following example examined the efficacy of the granules of Example 4 in managing FAW populations in corn.

Formulations:

FAW granule formulations, MCC (PRX-01GA1-21000) and 70C (PRX-01GA1-21002), are biodegradable granules used in this study. PRX-01GA1-21000 is composed of microcrystalline cellulose, polycaprolactone, and a FAW blend (87% Z9-14Ac+13% Z11-16Ac). PRX-01GA1-21002 is composed of calcinated kaolin, polycaprolactone, and the FAW blend.

Study Design:

Four trials to evaluate FAW male moth suppression (mating disruption) efficacy for the two formulations were performed in Rondonopolis-MT and Itiquira-MT. Three doses of each formulation (50, 100 and 150 g a.i./ha/application) were tested in 2-3 ha plots and compared with a negative control (no application of any pheromone) and a positive control (Dispenser SF2.5VP, 75 g a.i./ha/application). Granule treatments were applied once by tractor or manually, depending on location, and FAW Pherogen® film dispensers were installed at the same time. Four delta traps with a FAW specific pheromone lure were placed within each pheromone treatment and eight delta traps for the negative control, also labelled as CGP (Common Grower Practice) in a randomized fashion. Each trap represented a replication. Males trapped were monitored twice a week for 80 days. Efficacy of each formulation and dose was measured by accumulated FAW male moth captures through time and space for each respective formulation and treatment throughout the entirety of each trial.

Moth Capture:

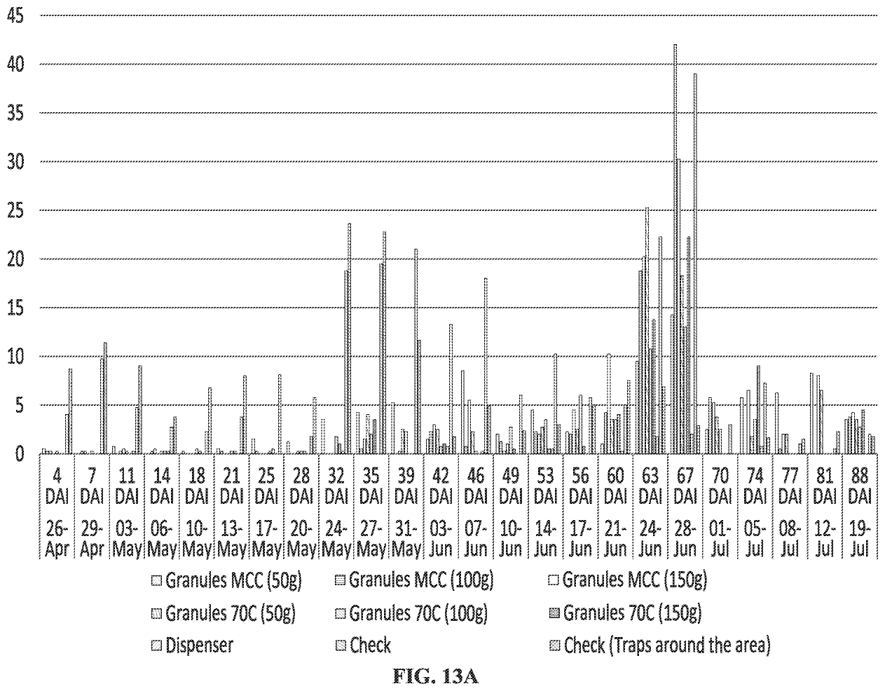

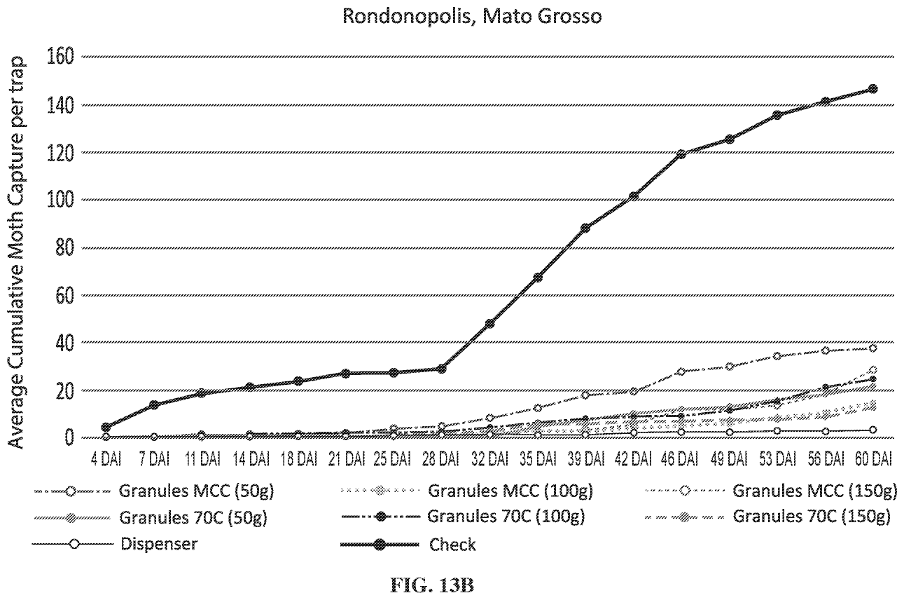

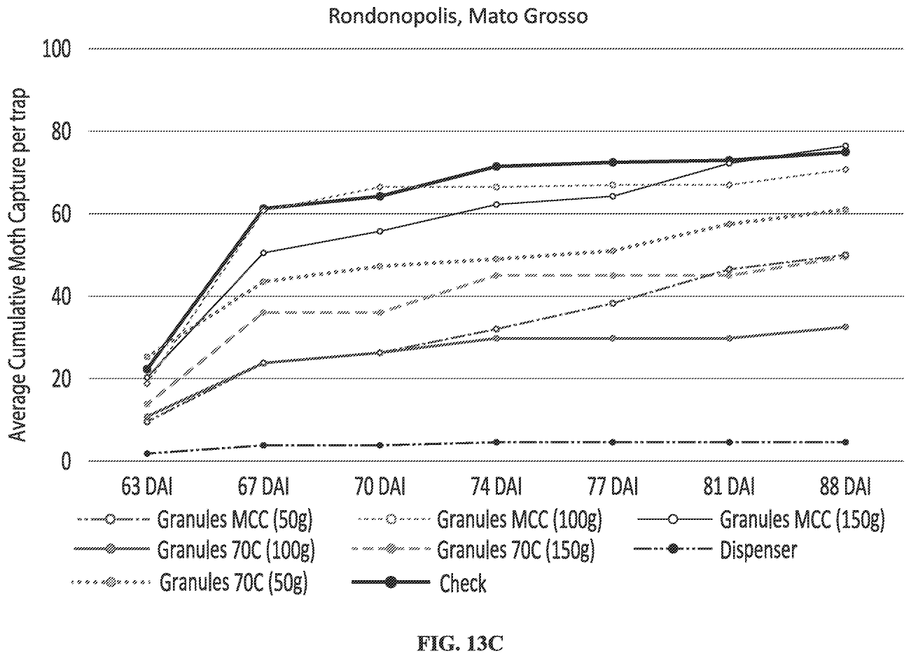

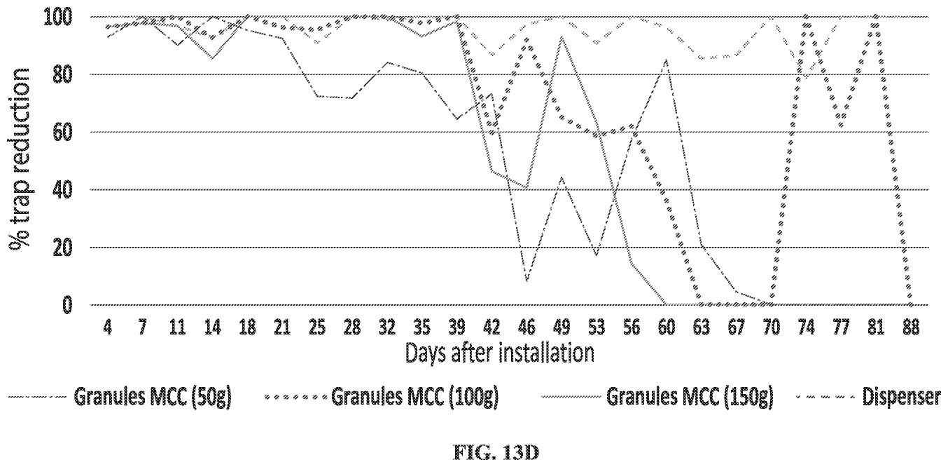

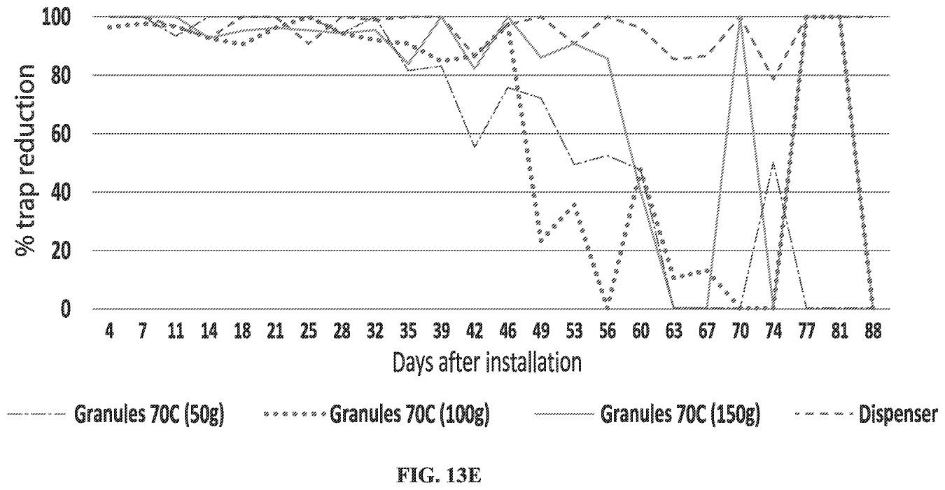

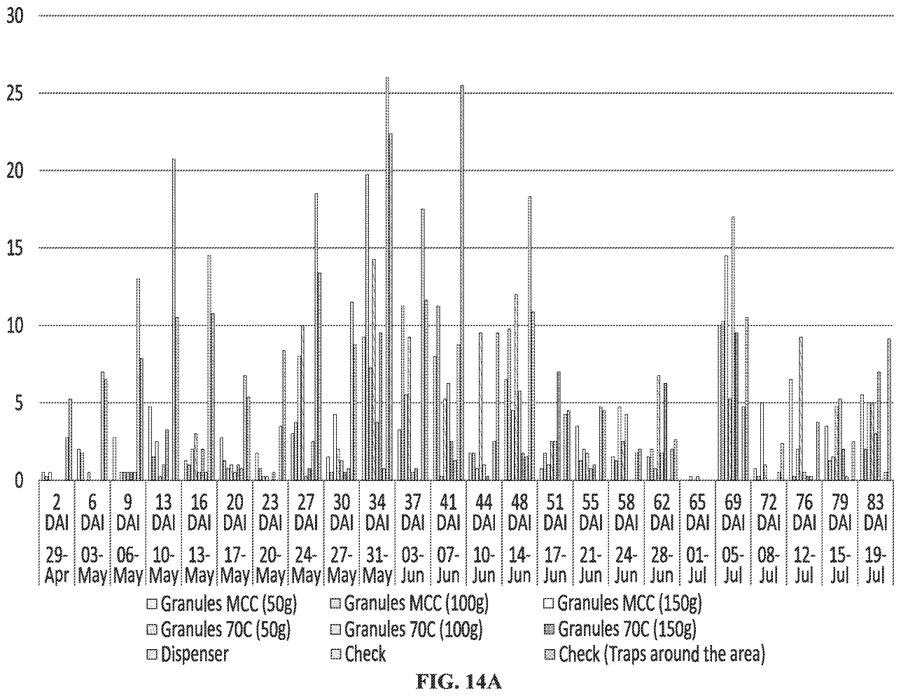

All formulations and doses effectively reduced male moth captures between 28-32 DAI in Rondonopolis-MT (FIG. 13A) compared to negative controls. The formulations continue to exhibit moth reduction until 60 DAI with the efficacy decreasing after 60 DAI (FIGS. 13B-13C, respectively). Formulation 70C tested at 100 and 150 g a.i. had the lowest FAW male moth captures demonstrating 97% and 85% of trapping reduction (at 46 DAI and 56 DAI, respectively) (FIGS. 13D-13E).

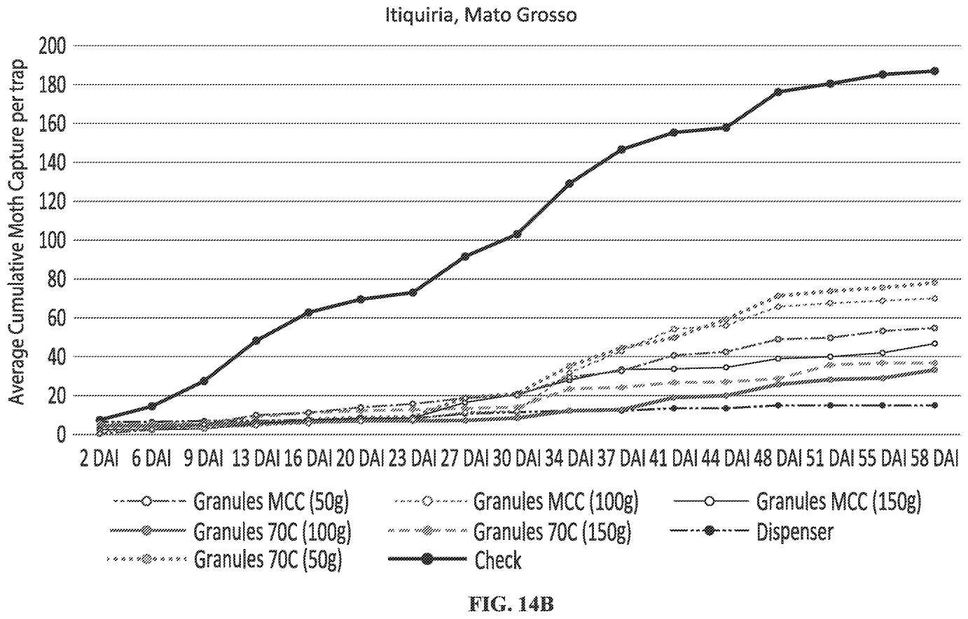

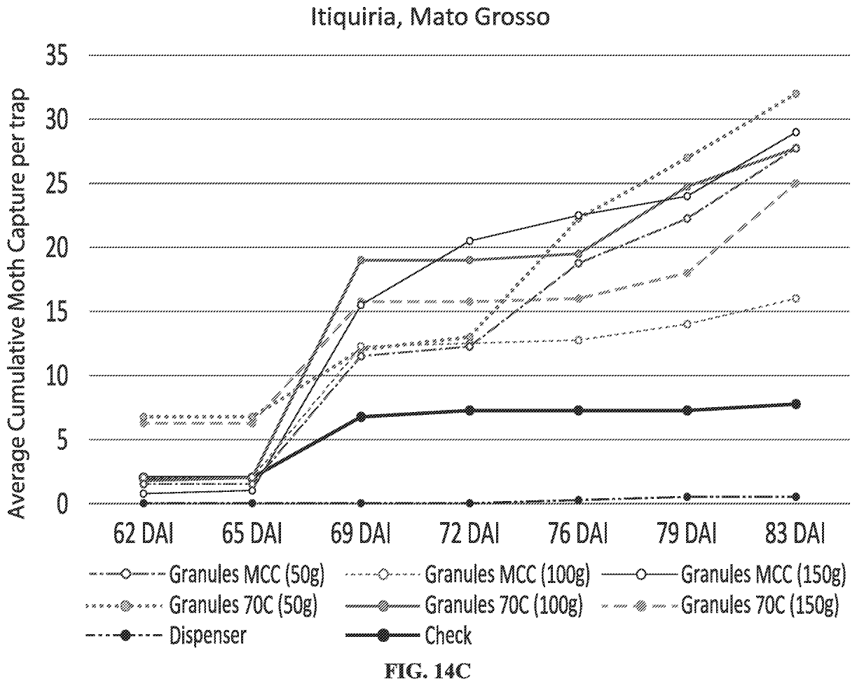

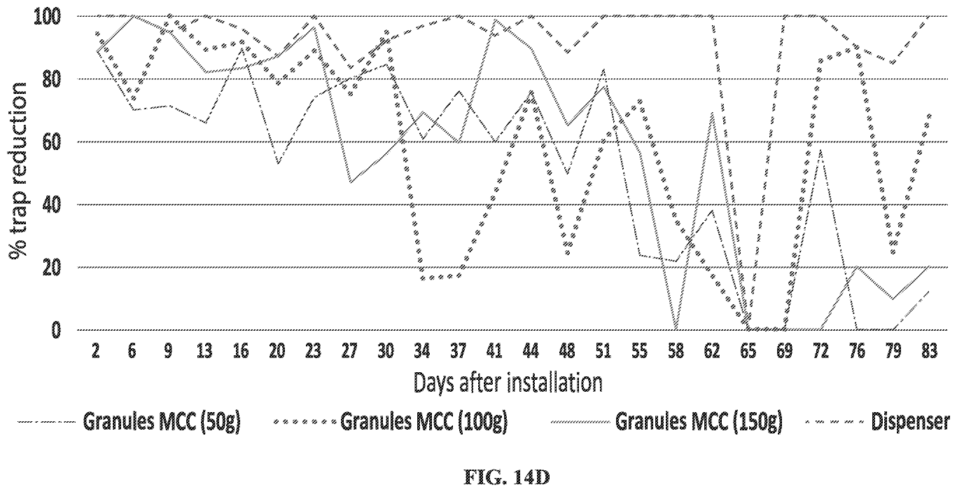

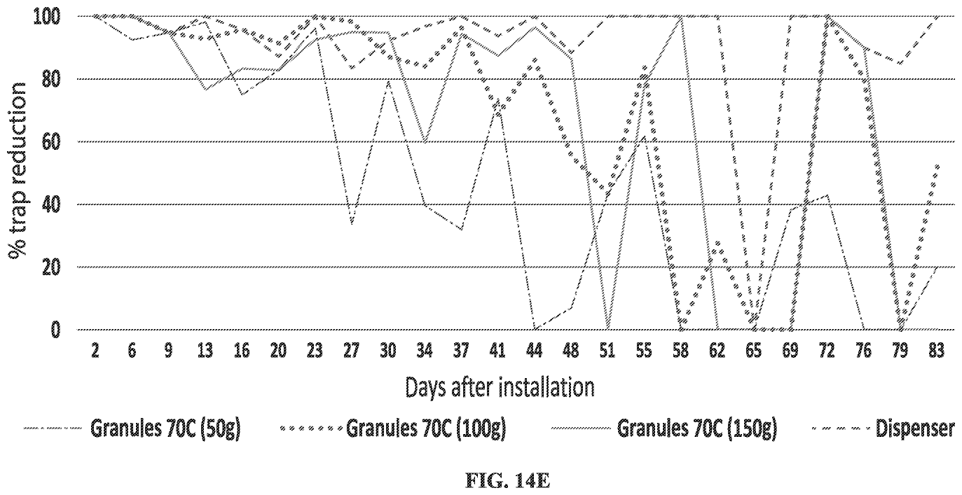

All formulations and doses reduced FAW male moth captures for the first 30d after installation (DAI) in Itiquira-MT (FIG. 14A) compared to negative controls. The formulations continue to exhibit moth reducing until 60 DAI with the efficacy decreasing after 65 DAI (FIGS. 14B-14C, respectively). Formulation 70C tested at 100 and 150 g a.i. doses showed the lowest FAW male moth captures demonstrating 86% and 86% of trapping reduction (at 44 DAI and 48 DAI, respectively) in Itiquira-MT (FIGS. 14D-14E).

### CONCLUSION

Overall, FAW incidence at the beginning of the trials (until 32 days after installation (DAI)) was low (between 5 and 10 adults per trap) and high (between 20 and 40 adults per trap) between 42 and 67 DAI in Rondonopolis-MT. In addition, Formulation MCC showed trap reduction of males above of 80% for 30-39 days and Formulation 70C showed trap reduction of males above of 80% for 48 to 56 days. Lastly, Formulation 70C at the 150 g a.i./ha dose demonstrated the longest duration of numerical FAW male moth suppression.

1. A controlled-release agrochemical dispenser or granule comprising:
a matrix comprising a biodegradable polymer; and
a semiochemical composition contained within the matrix.

2. The dispenser or granule of claim 1, wherein the biodegradable polymer is selected from the group consisting of polycaprolactone (PCL), poly(butylene adipate-co-terephthalate) (PBAT), polybutylene succinate (PBS), polyhydroxyalkanoate (PHA) and polylactic acid (PLA).

3. The dispenser or granule of claim 1, wherein the dispenser comprises about 10 wt % to about 98 wt % of the biodegradable polymer.

4. The dispenser or granule of claim 1, wherein further comprising a non-biodegradable polymer.

5. The dispenser or granule of claim 4, wherein the non-biodegradable polymer is selected from the group consisting of low density polyethylene (LDPE), ethylene-vinyl acetate (EVA), high density polyethylene (HDPE), and polyvinyl acetate (PVA).

6. The dispenser or granule of claim 1, further comprising a filler contained within the matrix.

7. The dispenser or granule of claim 6, wherein the filler is selected from the group consisting of a clay (including organoclay), a zeolite, talcum, shredded hay, cotton, cork, hemp, wood chips, wood dust, wood excelsior, microcrystalline cellulose, paper pulp, kaolin, calcined kaolin, chitosan, and mixtures thereof.

8. The dispenser or granule of claim 1, wherein the dispenser comprises about 1 wt % to about 80 wt % of filler.

9. The dispenser or granule of claim 1, wherein the dispenser comprises polycaprolactone and microcrystalline cellulose.

10. The dispenser or granule of claim 1, wherein the dispenser comprises polycaprolactone and calcined kaolin.

11. The dispenser or granule of claim 1, wherein the dispenser comprises PBS and microcrystalline cellulose.

12. The dispenser or granule of claim 1, wherein the dispenser comprises PBS and calcined kaolin.

13. The dispenser or granule of claim 1, wherein the weight ratio of semiochemical composition to biodegradable polymer is 20:80 to 80:20.

14. The dispenser or granule of claim 1, wherein the weight ratio of semiochemical composition to biodegradable polymer is about 1:1.

15. The dispenser or granule of claim 6, wherein the weight ratio of filler to semiochemical composition is about 1:1.

16. The dispenser or granule of claim 6, wherein the ratio of the biodegradable polymer to filler to semiochemical composition is around 1:1:1.

17. The dispenser or granule of claim 1, wherein the dispenser further comprises an antioxidant.

18. The dispenser or granule of claim 1, wherein the dispenser further comprises a UV-blocking agent.

19. The dispenser or granule of claim 1, wherein the dispenser further comprises an anticaking agent.

20. The dispenser or granule of claim 1, wherein the dispenser is in the shape of a cylindrical disc or rectangular prism, or the granule is in the shape of a cylinder, cube, sphere, irregular 3d object, or a mixture thereof.

21. The dispenser or granule of claim 1, wherein the surface area of the dispenser or granule is from about 1 cm² to about 100 cm².

22. The dispenser of claim 20, wherein the thickness of the dispenser is from about 0.1 mm to about 10 mm.

23. The dispenser or granule of claim 1, wherein the semiochemical composition is selected from the group consisting of an allomone, a kairomone, a pheromone, and mixtures thereof.

24. The dispenser or granule of claim 1, wherein the semiochemical composition comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (Z)-9-Tetradecenyl acetate (Z9-14Ac), (E)-5-Decenyl acetate (E5-10Ac), (E,E)-8,10-Decadienyl acetate (E8E10-10Ac), (E,E)-8,10-dodecadien-1-ol, (Z)-11-Hexadecenyl acetate (Z11-16Ac), and mixtures thereof.

25. The dispenser or granule of claim 1, wherein the semiochemical composition comprises (Z)-9-Hexadecenal (Z9-16Ald), (Z)-11-Hexadecenal (Z11-16Ald), (Z)-13-Octadecenal (Z13-18Ald), and (Z)-9-Octadecenal (Z9-18Ald).

26. The dispenser or granule of claim 1, wherein the dispenser comprises about 1% to about 50% by weight of the semiochemical composition.

27. A controlled-release agrochemical flake comprising
a matrix comprising a biodegradable polymer; and
a semiochemical composition contained within the matrix.

28. The granule of claim 1, wherein the mean volume of the granule is from about 0.001 mm³ to about 1000 mm³.

29. A method of controlling fall armyworm (FAW) in corn, the method comprising applying an effective amount of the controlled-release agrochemical dispenser or granule of claim 1 to a corn field.

30. The method of claim 29, wherein the method controls FAW for at least 30 days following application.

31. A method of controlling yellow rice stemborer in rice, the method comprising applying an effective amount of the controlled-release agrochemical dispenser or granule of claim 1 to a rice paddy field.

32. The method of claim 31, wherein the method controls yellow rice stemborer or striped stemborer for at least 30 days following application.

33. A process for making a controlled-release agrochemical dispenser, flake or granule, the method comprising:
(a) homogenizing a filler, binder and a semiochemical composition; and
(b) extruding the homogenized mixture.

34. The process of claim 33, wherein the step (b) is conducted by twin-screw extrusion.

35. A method of controlling a pest in a field, the method comprising applying an effective amount of the controlled-release agrochemical dispenser or granule of claim 1, wherein the method controls a pest for at least 100 days after installation in field.
